(19) United States
(12) Patent Application Publication
(10) Pub. No.: US 2009/0281835 A1
(43) Pub. Date: Nov. 12, 2009

(54) Medical prescription scheduler for reminding and compliance

(76) Inventors: Ravindra Patwardhan, Pune (IN); Rajeev Pandit, Parkland, FL (US)

Correspondence Address: Rajeev Pandit, 6847 nw 107th terrace, Parkland, FL, 33076, US

(21) Appl. No.: 12/387,270

(22) Filed: Apr. 30, 2009

Related U.S. Application Data
(60) Provisional application No. 61/133,750, filed on Jul. 3, 2008.

(30) Foreign Application Priority Data
May 7, 2008 (IN) 981/MUM/2008
Nov. 17, 2008 (IN) 2423/MUM2008

(51) Int. Cl. G06Q 50/00; G04B 47/00; G06F 3/048; G06Q 30/00; G06F 12/00

(52) U.S. Cl. 705/3; 368/12; 715/780; 705/2; 711/103; 715/224; 715/843; 705/14.55; 705/14.64; 711/101; 711/E12.001

(57) ABSTRACT

A medical prescription scheduler for reminding and compliance is basically envisioned and devised to simplify the programming of a reminder device, and comprises of a single device or a pair of complimentary devices. A scheduler device is meant for achieving a speedy and facilitated scheduling of a medical prescription, formatting the scheduled prescription based on format specifications compliant with the prescription reminder application program of a recipient reminder device, and transmitting the formatted scheduled medical prescription to the reminder device. When unpacked in the receiving reminder device, said format is intended for realizing the programming of the reminder device. And the programmed reminder device is capable of audio-visually reminding each dose of each medication of said prescription till compliance. Preferably, the scheduler and reminder devices are modified commonly used electronic devices, wherein either the existing hardware and/or software is suitably adapted or the requisite hardware and/or software is incorporated so as to accomplish the scheduling and reminding function. While inputting a prescription, the computing means of a scheduler device assists a prescriber by performing relational analysis and by displaying cautionary or advisory information. In addition to facilitating a doctor in scheduling a medical prescription, a means for promoting pharmaceutical products and generating revenues is included.

### RELATED APPLICATIONS

Priority is claimed for US provisional patent application:

An application claiming the benefit under 35 USC 119(e)
US Provisional patent application number: U.S. 61/133,750
Filing date: Jul. 30, 2008
Priority claimed: Yes

Priority is also claimed for two Indian patent applications (foreign patent applications):

1) Provisional Patent Application number: 981/MUM/2008
Filing date: May 7, 2008
Priority claimed: Yes

### Country: IN (India)

2) Nonprovisional Patent Application number: 2423/MUM/2008
Filing date: Nov. 17, 2008

### Country: IN (India)

Priority claimed: Yes

All of the aforementioned patent applications are incorporated herein in their entirety by reference.

### BACKGROUND OF THE INVENTION

1. Field of the Invention

This invention mainly relates to a complimentary pair of devices for simplifying the programming of a reminder device and reminding each dose of each medication till compliance. A scheduler device aims at achieving a facilitated scheduling of a medical prescription, formatting the scheduled prescription on format specifications compliant with recipient reminder device and transmitting the formatted scheduled medical prescription to the reminder device. When unpacked in the reminder device, the received formatted scheduled medical prescription is designed for realizing the automatic programming of the reminder device and the programmed reminder device is meant for reminding each dose of each medication of said prescription.

2. Description of the Related Art

Reliability in taking medication at home is appreciably erratic. The use of electronic alarm devices, which point out the medication time, is a well-known fact. Actually, the prior art is crowded with various designs of electronic alarm devices, devised to generate audible and/or visible alarm signals. U.S. Pat. Nos. 6,198,383 and 6,018,289 are examples of such electronic devices. A problem with such systems is that they are relatively complex devices and difficult to program. An aging population, insurance coverage, and chronic conditions occurring frequently in elderly have enhanced consumption of prescription drugs and compliance can be extremely demanding.

A need therefore exists for a reliable and effortlessly programmable electronic device that points out the medication time. If a formulated medical prescription could be transmitted in a reminder device, and which could program the reminder device to implement the reminding function, the dilemma of programming a reminder device could be evaded. If such a resource were available, it would be further desirable that a facilitating system should be provided to a doctor to formulate a medical prescription. United States Patent Application number 20080071572 (Ahmed; Omar) embodies a GUI based scheme to select drugs by identifying symptoms or ailments and inputting them in the system, wherein, the system provides a list of drugs associated with treating said symptoms or ailments. The drugs are selected from the provided list. However, the symptoms may relate to numerous possible etiologies and symptomatic treatment is rarely advocated. It is better to pass the responsibility of diagnosing and deciding medication on to the doctors. Moreover, the method employed is for the users to select a drug dispensing location and communicate the prescription to that location.

It is also desirable that while a doctor is formulating a prescription, a relational analyzing system should be available, which could automatically display various precautions, special directions, drug interactions, adverse side effects, contraindications, safety cautions, recheck messages. United States Patent Application (Yamada; Satomi) 20080059229 describes a prescription assisting central apparatus connected through a network to a plurality of terminals installed in medical facilities. However, it does not teach an inbuilt independent relational analyzing system.

The main objective of the present invention is to provide a scheduler device for facilitating a prescriber for scheduling a medical prescription, configuring a format of said prescription compliant with format specifications of a reminder device and transmitting it to the reminder device. When unpacked, the received formatted scheduled medical prescription should realize automatic programming of the reminder device. And a programmed reminder device is intended for reminding each dose of each medication till compliance.

The present invention also aims at modifying and upgrading commonly used computing devices to include the scheduler function, and further aims at modifying and upgrading commonly used hand held trendy devices like a cell phone or a digital diary to include the reminding feature. United States Patent Application (Lawless; Oliver Charles) number 20070168228 exemplifies scheduled real-time wireless prescription dosing reminders through mobile phones and having a user's compliance through two way messaging. However, instead of using an independent reminder device for reminding, said patent application utilizes involvement of an external agency through which the reminding is achieved.

Thus, the rationale of the present invention is to provide new scheduling and reminding means, which have many advantages and novel features that are not anticipated or implied by any of the prior art.

### BRIEF SUMMARY OF THE INVENTION

A medical prescription scheduler for reminding and compliance mainly aims at achieving a speedy and facilitated scheduling of a medical prescription, which is formatted and transmitted in a reminder device. When unpacked, the formatted scheduled medical prescription is meant for realizing the programming of the recipient reminder device, which in turn is intended for audio-visually reminding each dose of each medication of the received said prescription till compliance. Thus, means are included for simplifying the programming of a reminder device. A means for generating revenues is also included by setting aside advertising space for the eternally hungry pharmaceutical companies.

### BRIEF DESCRIPTION OF SEVERAL VIEWS OF THE DRAWINGS

1) FIG. 1 is a schematic representation of the arrangement of essential components of a scheduler device.

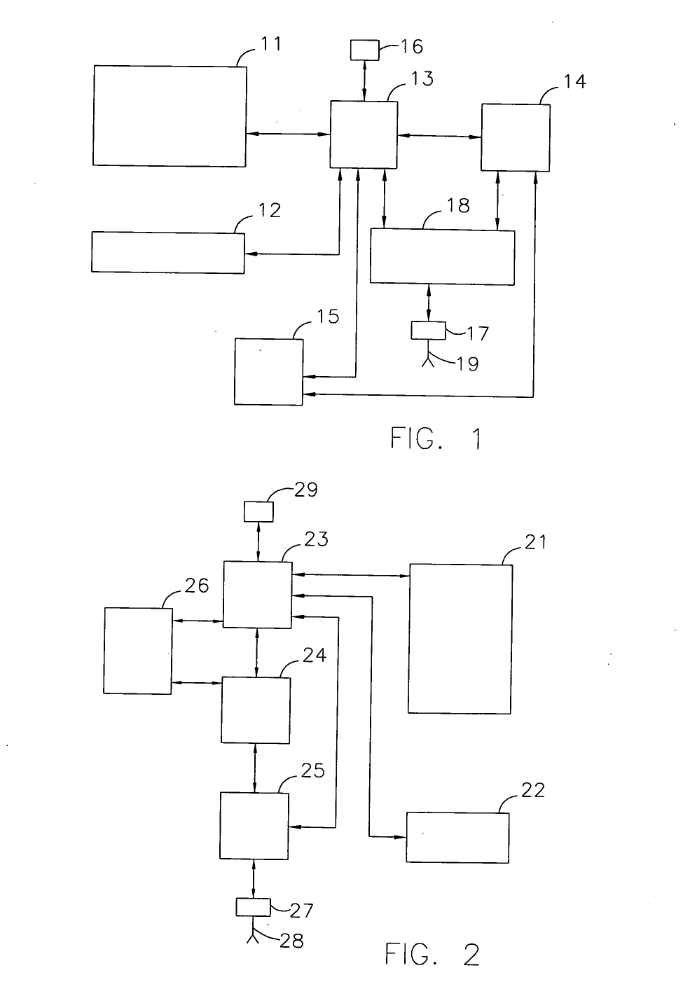

2) FIG. 2 is a schematic representation of the arrangement of essential components of a reminder device.

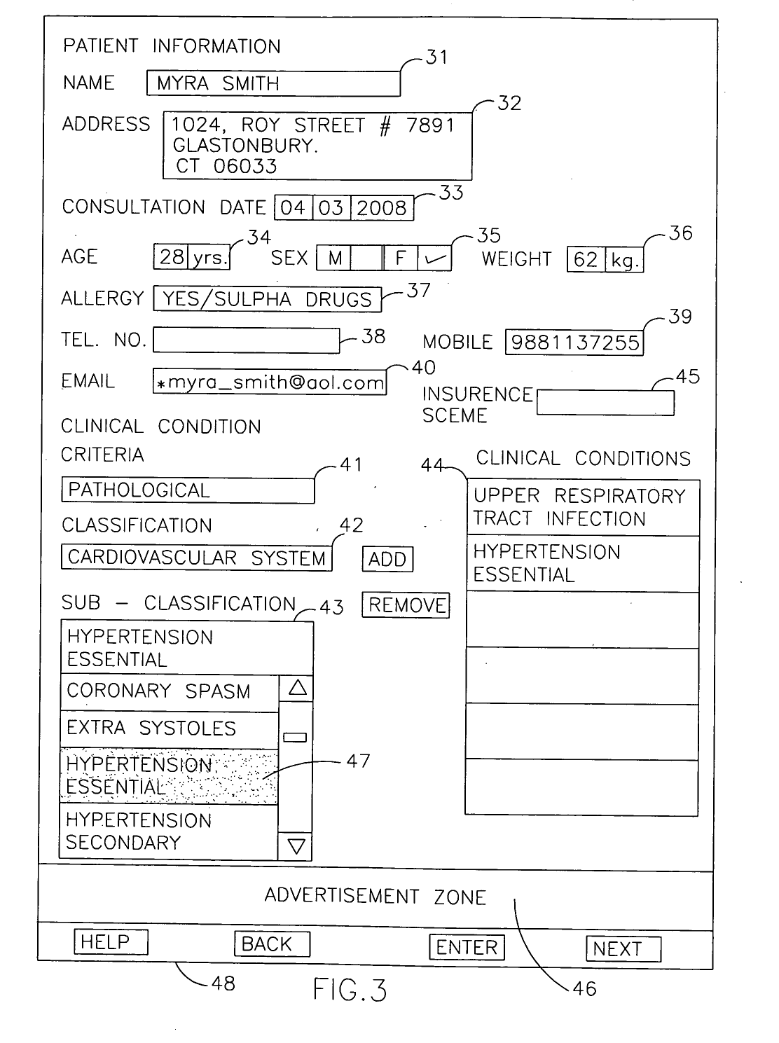

3) FIG. 3 is a GUI illustration depicting patient information input screen for inputting patient related data.

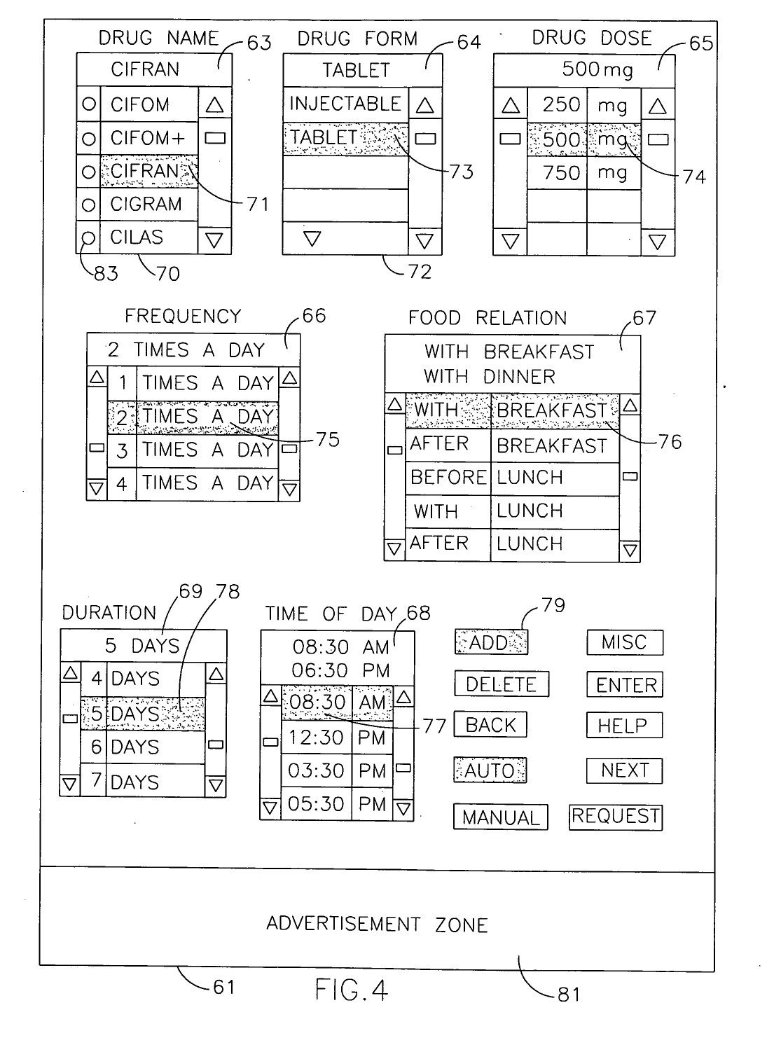

4) FIG. 4 is a GUI illustration depicting a prescription scheduling screen for inputting a prescription.

5) FIG. 5 is a GUI illustration of a prescription content screen depicting inputted prescription.

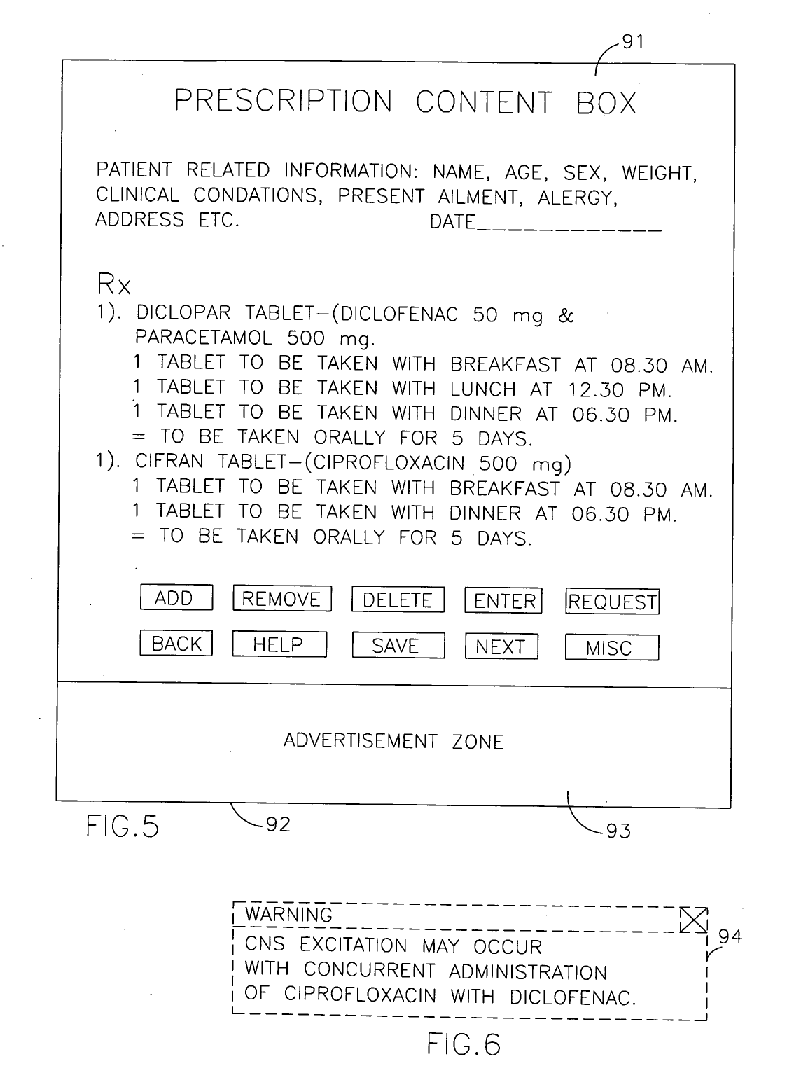

6) FIG. 6 is a popped up dialogue box displaying a warning.

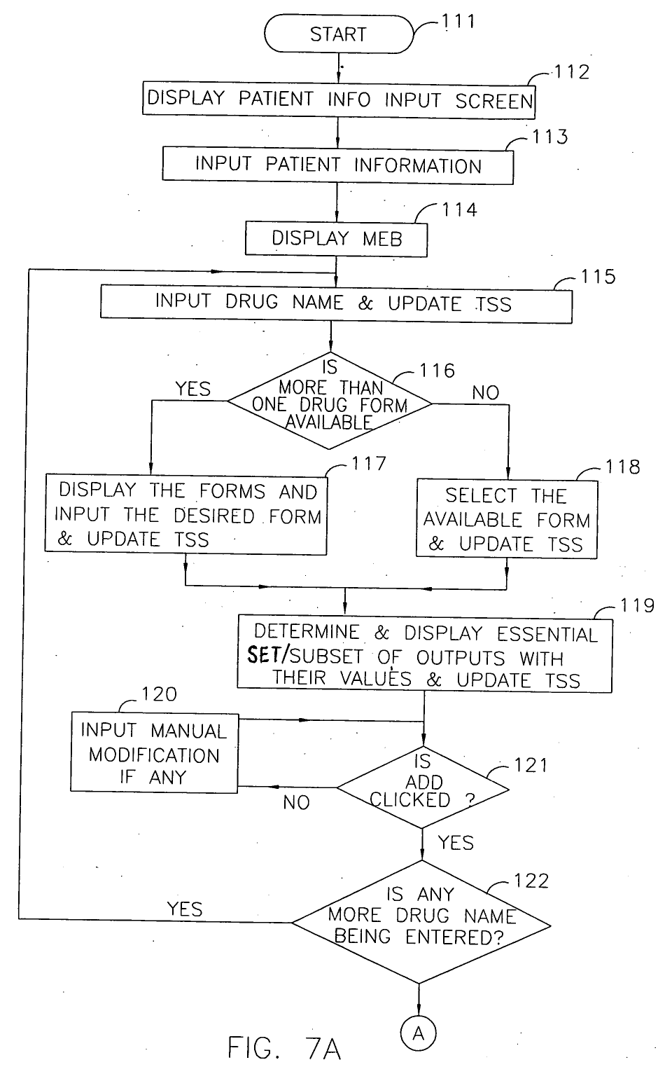

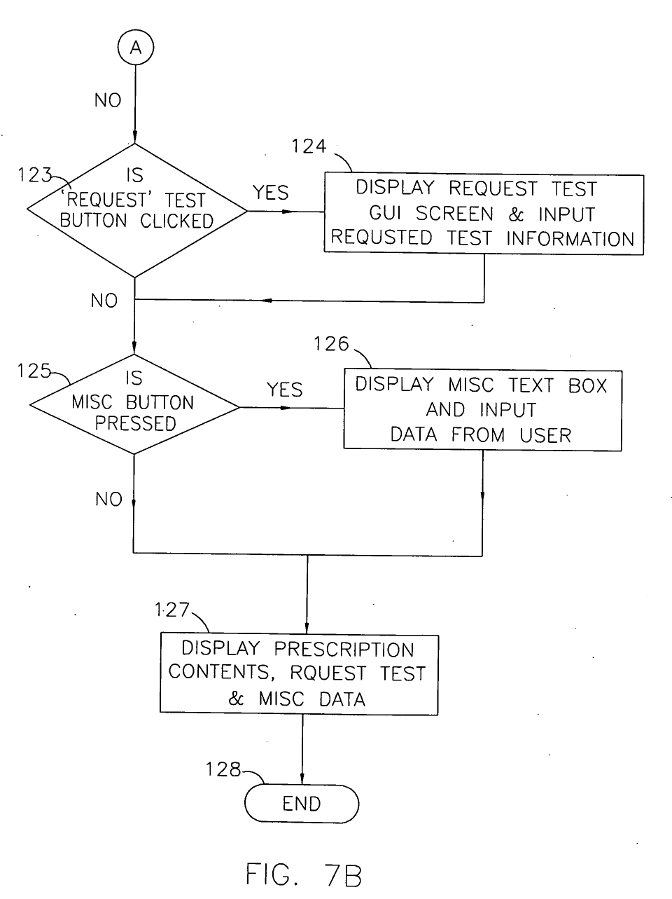

7) FIG. 7 A illustrates a flowchart of the sequence of steps pertaining to the process of inputting medications, requests, and miscellaneous text.

8) FIG. 7 B is a continuation of flowchart depicted in FIG. 7 A.

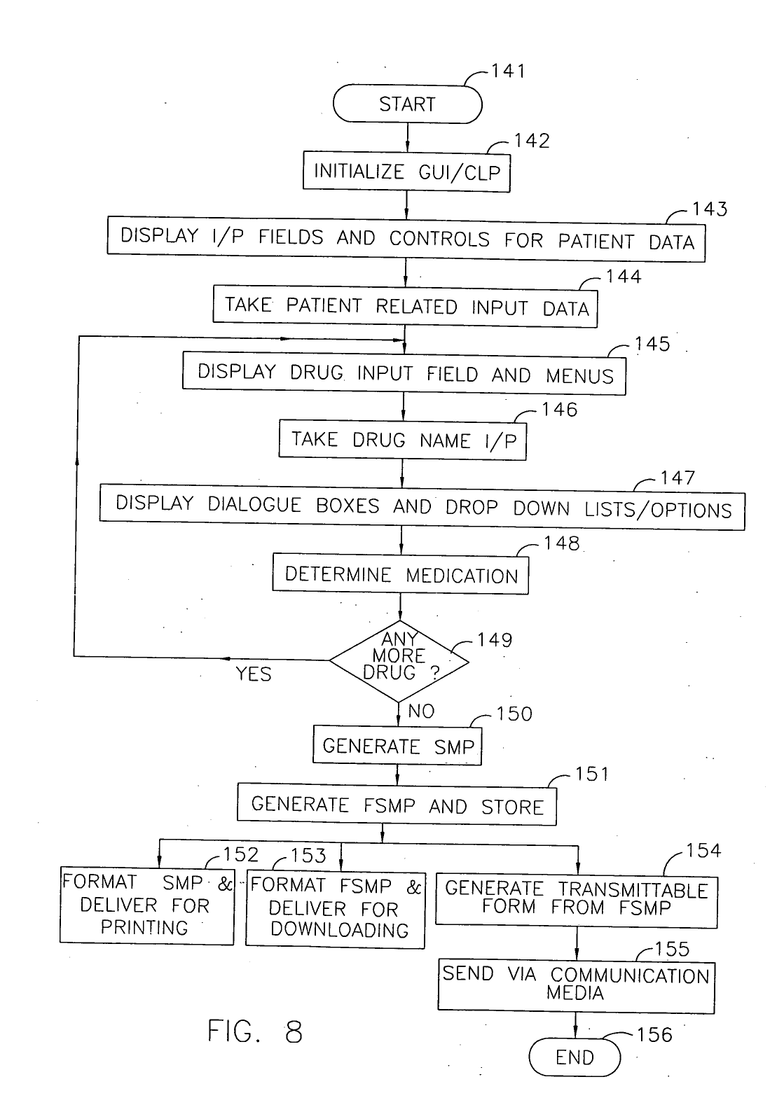

9) FIG. 8 illustrates a flowchart of the sequence of steps pertaining to the generation, formatting and transmission of a scheduled medical prescription.

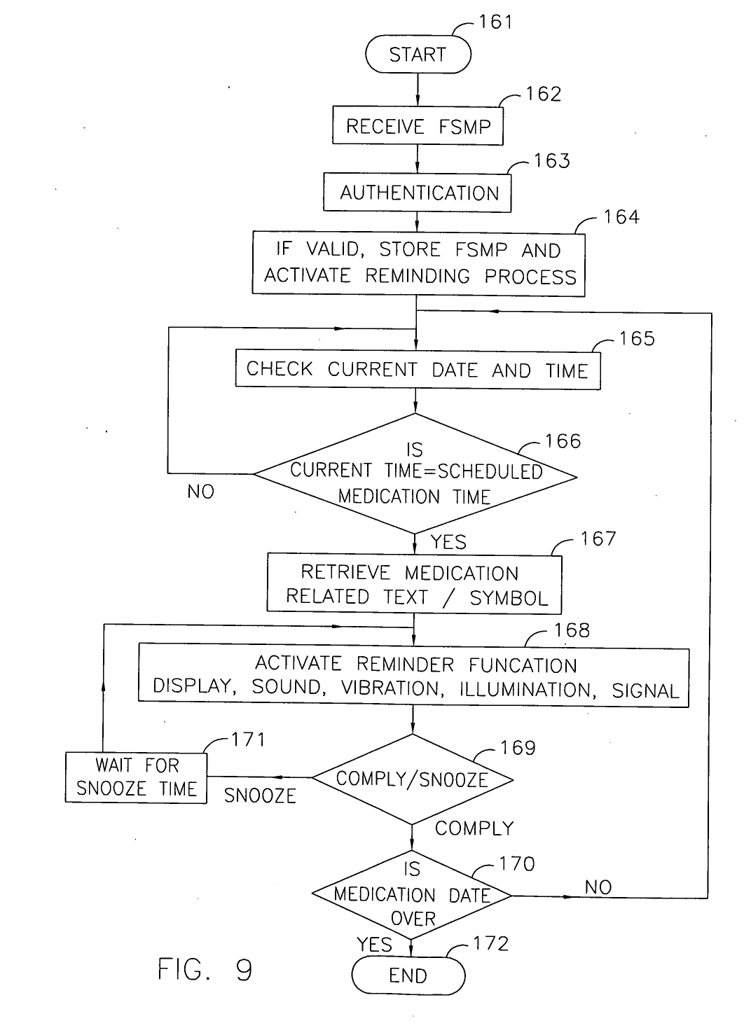

10) FIG. 9 illustrates a flowchart of the sequence of steps pertaining to the process to implement the reminding function for the received formatted scheduled medical prescription in a reminder device.

### DETAILED DESCRIPTION OF THE INVENTION

A medical prescription scheduler for reminding and compliance is either a single device meant for executing scheduler and reminding function or a complimentary pair. One of the units of said complementary pair, a scheduler device, is meant for scheduling a medical prescription, and formatting and transmitting it to a suitable reminder device. The other unit of said complementary pair is a reminder device for receiving the formatted scheduled medical prescription (FSMP) and executing a reminding function till acknowledgement. A scheduler function comprises facilitating a doctor for quickly formulating a medical prescription, and formatting and transmitting it to a reminder device. An electronic computing device capable of carrying out scheduler function is a scheduler device (SD). An electronic computing device, if somewhat deficient in scheduler function and which is upgradeable with the hardware and/or software pertaining to that deficiency and which is upgraded accordingly is hereafter called as integrated scheduling device (ISD). The process of upgradation is termed as integration. Thus, ISD is a modified computing device, wherein, either the existing hardware/software is suitably adapted or the requisite hardware/software is incorporated so as to accomplish said scheduler function. Such modification could be easily accomplished in personal computers, desktop computers, laptops, handheld computers, Pocket Personal Computers, Terminals or other computers, or hand-held devices such as personal digital assistants, palmtop computers, digital diaries and the like, or other devices capable of providing an input signal to the command processor. Or the scheduler function could also be integrated in a portable telephone like a cellular phone, a smart phone, a personal handy phone, a car telephone, a maritime mobile radiotelephone, or wrist-worn devices. Or a computing device could be suitably modified to utilize any appropriate computer readable medium having computer-executable instructions like a CD or a DVD to execute the scheduler function. Furthermore, instead of incorporating the scheduler function in a computing device, an independent compact dedicated scheduler device (DSD) can be configured. Such a DSD is designed to incorporate various necessary hardware/software for scheduling of the medical prescription, and if desired, executing the reminding function accordingly. Both ISD and DSD essentially have the same bottom line and fundamentally have the same function and thus henceforth referred to as scheduler device (SD).

Referring to FIG. 1, schematically depicting one of the preferred embodiments, a SD comprises of a computing means capable of executing computer codes/programs that define the operating system software or application software. Said computing means includes a central processing unit (CPU) 13 that preferably includes one or more processors/micro-processors and/or one or more digital signal processors. Input/output port 16 is for exchange of data with other devices. Transmit/receive port (or ports) 17 like RS232, USB, SPI, I2C is connected to CPU 13 via transceiver 18 for download/upload of data from/to other devices. This interface is also used to communicate information and is adapted to be linked to a communication system for transmission. The communication system is a combination of hardware like antenna 19, communication ports 17 like USB or Ethernet, modem, and software like socket communication drivers, transmission control protocol, Internet protocol stack, bluetooth stack etc. The CPU is coupled to memory means 14. The memory (memory means) 14 may be read-only memory (ROM), random access memory (RAM), erasable programmable read only memory (EPROM), electrically erasable programmable read only memory (EEPROM), magnetic or optical cards, or any type of media suitable for storing electronic data, or may be a combination of known FLASH, RAM, NV-RAM, ROM, EEPROM or magnetic/optical memory, or any type of disk including hard disc, floppy disks, optical disks, CD-ROMs, and magnetic-optical disks. Or the memory may be stored in any other external storage media that could be accessed by the CPU. The memory 14 stores multiple lists, relational data, and details related to each list member, application software including CPU-executable code, and assorted operating parameters for the processor. The processor performs the requisite functions by executing the application software. The memory may selectively store entities like operating system software and the ones like multiple lists may be retrieved from external means like connected servers or clients or connected memory units. Memory stores names of plurality of prescription drugs, preferably ‘brand names+generic names’, in an alphanumerical or alphabetical indexed order. For each brand name, its ingredient generic name/names are stored. In allopathic medicine, a ‘brand name’ (trade name) is an invented name, which is protected by a trademark. The term ‘generic name’ implies marketing a product of a therapeutic agent, wherein the same pharmacological name is used for that product. In other words, a generic name refers to a drug sold under a name that is not protected by a trademark. Memory means also stores information related to each generic name, which contains highlights of pharmacology and pharmacokinetics. Said highlights of pharmacology, preferably related to each generic name, comprise therapeutic actions, indications, recommended range of indication-wise and form-wise dosage, maintenance dosage range, range of duration of drug administration, safety alerts, contraindications, precautions, drug interactions, potential hazards, adverse effects, lab interference. And said highlights of pharmacokinetics of each drug comprise duration of absorption, systemic bioavailability, activity, metabolism and elimination of each drug, and interactions with food pertaining to absorption and/or bioavailability. Pharmacology and pharmacokinetics are very well known sciences and there is no need to enlarge any further in this regard. By the term ‘highlights’, it is implied that preferably the facts and figures regarding pharmacology and pharmacokinetics are stored in suitable precise/tabulated format suitable for computer algorithms. The memory also stores current inputted prescription data and inputted patient related information like age, gender, weight, clinical conditions, allergy, physical status, severity of ailment etc and patient specific identifier/s for transmission.

Commands may be actuated through the keyboard 12 or any other pointing device. A user may interact with application software using any of the input means like a keyboard 12 or a voice input/output device 15 or a mouse or a touch-pad or a trackpad or a cursor control to generate keystroke signals. A key/click analyzing section generates a predefined key/click event and the CPU (computing system) controls and executes a function corresponding to the generated event. A voice input/output unit is optional and is meant for user interaction with application software. A display screen 11 is for display and may be a liquid crystal display or a cathode-ray tube or a plasma screen or the like, with or without touch sensing facility.

The operating system may include either a plurality of graphical user interfaces or application specific graphical user interfaces or command line interfaces. Preferably a window, icon, menu, pointing device-based (widget based) graphical user interfaces (GUI) are used that allows a user to interact with the application software. A GUI in the SD is a platform that a user can interact with for the tasks of inputting, analyzing, retrieving and producing information. Application software mainly consists of assorted programs compliant with the operating system and the GUI, and written to receive inputs from a physician/user and to display various menu items, options, information, drop down lists, pull-down/pop-up menu, window-in-window, dialogue boxes, a linked document, any other format and sub-screens.

The templates (domains) of GUIs are constructed in an insightful manner. Each GUI has a distinct template and a characteristic input region. GUIs may either be designed to be displayed in succession on the basis of the manner in vogue that exists in writing a medical prescription or on the basis of selection of a drug name and/or its drug form or on the basis of selection of a button like REQUEST or MISC. While sequentially displaying the insightful display screens, desired additional identifiers may be displayed at relevant coordinates. One of the frequent ways is the display of a window frame (Window-in-window), which appears with the requested display of a list/information or appears to display relational information. Various types of commonly used prompts could be provided to navigate through the diverse menus and fields. Using scripting languages like structured hypertext markup language, it is possible to create visually appealing vertical or horizontal drop-downs or pop-ups that are easy to work with and to edit and update.

The data could be stored in said memory as records having a number of attributes/fields (data sets). A data set may comprise of a list of sequentially ordered alphabetically or alphanumerically indexed list members (for example, drug names), or member related information. Each data set corresponds to one of the identifiers like an icon or an option or a term. A desired data set can be selected and outputted by actuation of a control input like a select control or a scrolling control, or automatically outputted, or at times outputted by default. The drug databases of the SD would contain a listing of all those drugs available in the geographical region of the medical practitioner, and would vary from region to region. For example, although, most of the drugs available in India are available in the United States, and vice versa, nevertheless, the drug database comprising most of the brand names available in India would not be on a database designed for use for the United States. In addition to the hereinabove described databases, one or more special databases like relational databases are included, wherein, facts and figures related to constraints with respect to, but not limited to, age, gender, weight, clinical conditions, allergy, physical status, drug association, drug intake versus each of the prescribable medicine are stored. While preparing a medical prescription, all relevant relational data is fetched from such databases and used for calculations or analysis. The relational data is typically pre-stored in memory means but it could also be created at run-time by the application software and updated. Generally, in a relational database, the basic unit of data is a relation. A relation corresponds to a table having rows and columns. Generally, rows represent records of related data and columns identify individual data elements. The order of the rows and columns in a table are inconsequential. In a relational database, one can add a new column to a table without having to modify older applications that access other columns in the table. Relational databases thus provide flexibility to accommodate changing needs and allows the application software to interchange and cross-reference information between two different types of records.

Dialog boxes display relational information and are meant for an interaction between the computing system and the user. More particularly, dialog boxes are used either for informing the user of drug interaction or contraindications or major side effects, or requesting the user if the inputted dosage is to be rechecked, and generally require only an acknowledgment by clicking ‘OK’ indicating that the message has been read. Relational information could also be presented by identifying appropriateness of a displayed therapeutic agent. When a drop down list is being displayed for drug name selection, the listed therapeutic agents could be highlighted using a color scheme/indication to indicate suitability/unsuitability of a therapeutic agent for medication. For example, if a patient is allergic to sulpha drugs, the displayed brand name in a drop-down-list would have red indication for co-trimoxazole and green for cephalexin indicating that the former is contra-indicated and the latter may be considered a valid option. FIG. 4, dot 83, depicts such a highlighting-dot positioned in the vicinity of a displayed drug name.

Various display-schemes described hereinafter are exemplary and those experts in the art can very well recognize that numerous variations are possible without departing from the main theme. The initial presented window, as depicted in FIG. 3, is a data entry screen 48 (data entry window). It is presented for inputting patient related information and displays a plurality of designated active workspaces. When a cursor is located within an active workspace, associated patient related information may be inputted. The user can interact with any of the displayed option by placing the cursor over it and selecting it. Options like ‘back’, ‘cancel’, or ‘exit’ allow a user to navigate to various screens. An ‘enter’ option indicates the system that the entry of information is over and a ‘next’ option allows the user to attend the next domain. When a SD software is activated, the screen 48 as depicted in the FIG. 3, initially presents input boxes associated with patient related information, namely name (input box 31), address (input box 32), age (input box 34), sex (input box 35), weight (input box 36), allergy (input box 37), date (input box 33). Information about patient's diagnosed clinical conditions would be vital for the application software, which assists a user by automatically determining a dosage schedule for an entered drug name. The screen depicts input box 41 for inputting criteria of clinical condition, input box 42 for classification, input box 43 for sub-classification and input box 44 for entered clinical conditions. Inputting through criteria signifies one of the methods for inputting clinical conditions. Once the criteria option is selected, a drop down list of its members like pathological, physiological, psychiatric, hereditary etc would be displayed for selection. When the term ‘pathological’ is selected (input box 41), a drop down list of system-wise captions of pathological conditions like alimentary system, allergic disorders, cardiovascular system etc would be displayed, which can be scrolled to select the intended name (member/term) of the system. The selected member would direct the searching, retrieving and displaying related members. If ‘cardiovascular system’ were selected as depicted in FIG. 3, input box 42, the automatically displayed drop down list of related illnesses (related members), which can be scrolled to detect and select the intended term would be like coronary spasm, extra systoles, hypertension essential, hypertension secondary. FIG. 3 depicts the selection of ‘hypertension essential’ (depicted as a shaded box 47), which is automatically entered in the listing of the clinical conditions 44. The other clinical condition listed is ‘upper respiratory tract infection’. For further exploring a term/member, a user can click that term/member to have a quick glance at related therapeutic agents that can be reached through a diagnosed condition. For example, if the inputted term were arrhythmia, the displayed antiarrhythmic drugs would be: adenosine, amiodarone, atenolol, diltiazem, diisopyramide, lignocaine etc. In peculiar clinical conditions like renal impairment, the user would be requested to enter the serum creatinine value in mgs per 100 ml and/or creatinine clearance in ml per minute. Such values are needed in dose calculation of certain drugs. It is preferable that the user should input the ‘member’ of the member list of clinical conditions; given that, there are numerous clinical conditions where pluralities of synonyms or alternative expressions exist. For example, reactivation of chicken pox virus in a nerve ganglion resulting in skin rash, pain and blisters, technically known as ‘herpes zoster’, is also at places colloquially called as ‘shingles’. For this reason the relational database may include pluralities of synonyms or alternative expressions of each of the ailments or physiological-conditions or pathological-conditions and a preferred synonym could be replaced by the system itself. The selection of clinical conditions could also be inputted by sequential input of initial letters of intended clinical condition, wherein a drop down list of plurality of linked completion candidates would be displayed. The narrowing criteria would be associated with each sequential input of a successive letter or by actuating scrolling means. This would enable a user to identify and select the intended name of the clinical condition. The selected term would be entered automatically or could be inputted by clicking the ‘add’ button. The list of clinical conditions may also include conventional abbreviations like URTI (upper respiratory tract infection) or TAO (thrombo angitis obliterans) etc.

Input box 45 is for inputting the name of insurance company or health scheme. The input boxes like phone number (input boxes 38), mobile number (input box 39) and E-mail address (input box 40) are for location information for transmission of the formatted scheduled medical prescription. An input box for patient's language of choice may be included for switching the display in reminder device in that language. There is also an ‘ADD’ button and a ‘REMOVE’ button. The ADD button is clicked to enter the selected/inputted information and the REMOVE button is clicked to cancel the added/inputted information. In the lower portion of the GUI, there are conventional customary buttons like HELP, BACK, ENTER and NEXT. Advertisement zone (Ad zone) 46, as depicted, would preferably be present in the lower segment. Each advertisement in ad zone 46 is preferably linked with each newly inputted clinical condition like hypertension or diabetes or pregnancy. When the patient related data is inputted in the respective input boxes, the SD would automatically proceed to next stage of inputting (prescribing) a drug name. However, the SD software being user friendly would proceed by accepting with whatever is filled in the presented data entry window when the ‘enter’ or ‘next’ is clicked. A previously filled patient related data entry window may be called and updated to save the time. The data associated with the information about the patient would be vital for the application software, which assists a user by automatically determining calculated dosage schedules of each entered drug. Besides, the application software also performs relational analysis by utilizing the patient related data and correlating and analyzing it with the prescribed drug/drugs.

Subsequent to clicking ‘enter’ or ‘next’ on the data entry screen 48, the ensuing window would be a prescription scheduling GUI screen 61, as depicted in FIG. 4, to input a drug name, its form, dosage (dose) strength, time of day of each dose administration and its relation with food, technique of dose administration, frequency of doses per day, precautionary instructions and duration of administration. The prescription scheduling window (scheduler screen) 61 displays an active workspace like a medication input box (MEB) 63 for inputting of a drug name. Similarly, a user can interact with any of the displayed options by placing the screen cursor/pointer over the option and selecting it. Or one can select a ‘term’. For example, the inputted brand name of a drug itself becomes a ‘term’, which when clicked, would reveal constituent generic name/names of ingredient drug/drugs. Various options like ‘back’, ‘cancel’ or ‘exit’ allow a user to navigate to various menu screens. An ‘end’ option indicates the system that tackling with the opened screen is over and a ‘next’ option allows the user to attend the next step. MEB 63 is for inputting the name of the drug/medicament. When a cursor is located within the MEB 63, a drug-name can be inputted. When a certain drug name is intended for input, a user needs to input successive sequential letters of the intended drug name. In response to received partial text entry in MEB 63, the application software would automatically search, retrieve and display a drop down list 70 of alphanumerically ordered related completion candidates of stored ‘brand names+generic names’. The narrowing criteria are associated with successive sequential input of letters or by actuating scrolling means. This would enable a user to quickly identify and select the intended drug name. The intended term ‘cifran’ containing the antibiotic ‘ciprofloxacin’ is thus displayed and can be selected. FIG. 4 depicts a shaded box 71 for the selected ‘cifran’. Once a desired drug name is selected, like ‘cifran’ in present case, it is automatically inputted in the input box 63 and the text and symbol section (TSS) is updated for display in reminder device. In the scheduled medical prescription file, there is a section of scheduled prescription data, which represents scheduled prescription display data and scheduled prescription time data. Said display data is preferably graphic data for display in the reminder device comprising of text and symbols related to each dose of each medication, and said time data represents scheduled medication time for each dose of each medication and duration of drug administration for each medication. This section is hereinafter called as text and symbol section (TSS). The TSS is updated simultaneously while scheduling a prescription, wherein, for each inputted/deleted entry like name, form, frequency, duration etc, a corresponding text/symbol/time data is inserted or removed respectively. For example, when the drug name ‘cifran’ is inputted, the said drug name is inserted as text in the TSS. In the reminder device, this data would be displayed as a text ‘cifran’.

Medicines of other systems like Ayurveda, Homoeopathy, naturopathy, alternative medicine, herbal medicine, Chinese medicine etc could also be included. At many places, doctors cannot prescribe drugs that are not associated with their education and practice. Using a specific drug database of prescribable drugs would eliminate confusion with other non-prescribable drugs. Or removable memory cards like Microdrive, connected to the computing device, containing a specific drug database based upon the medical practitioner's field of practice or location of practice, may be used to store drug related information.

Some insurance companies or health schemes or other medical schemes are known to insist certain brand names instead of the others, wherein the ingredients are same. If a patient were beneficiary of such company or scheme, a pop up message would notify the prescriber about the insisted brand name. And if Okayed, the selected brand name would be automatically replaced by the insisted brand name.

Once a drug name is selected and inputted in the MEB, a user can click the inputted drug name for exploration and appraisal of options like generic name of ingredient or ingredients, and highlights of the actions, indications, contraindications, dosage, adverse reactions, safety alert etc. Generally, for exploring a term (for example, the inputted drug name in present case), a user can identify the display state instruction, a mark, located on option line and employ it, or the entered ‘term’ itself would act as a command button and in accordance with the event that occurs when the command button is clicked, the section regarding the details of the selected option is opened.

Once a drug name is entered, a drug form is automatically selected and inputted if a single drug form exists. If a plurality of drug forms exists for the entered drug name, a drop down list of alphabetically ordered available drug forms would be displayed enabling a user to identify and select the intended drug-form. For example if the brand name ‘cifran’ were marketed as a tablet and an injection, then a drop down list of options ‘injection’ and ‘tablet’ would be automatically offered to the user to choose from. FIG. 4 depicts a drop down list 72 of available drug forms for cifran. Once ‘tablet form’ is selected, as depicted by shaded box 73, it is automatically inputted in the selectable input box for drug form 64. The drug name and its form, when selected, would be sufficient to pinpoint the technique of drug administration. The technique is directly related to drug form and is fine tuned with the drug name. For example, topical anti-inflammatory drug preparations (ointments or balms or creams) commonly used for sprains, myalgia and acute painful rheumatic conditions containing anti-inflammatory drugs like diclofenac or mephenesin are applied 3-4 times a day, while topical preparations containing rubefacients like turpentine oil or capsicum oleoresin are applied 3-4 times a day and gently massaged. The technique is automatically determined and inputted in the relevant input box and the TSS is updated for its display in reminder device.

The depicted prescription scheduling GUI screen 61 (FIG. 4) is for exemplification only and numerous variations are possible. Various prescription scheduling GUI screens (screen 61 displaying computed inputs for a tablet form) are created to cater the needs for entering various drug forms. The entered drug name (usually a brand name) with/without drug form would characterize the nature of the drug like a liquid oral or an ointment or a pessary or a balm or a tablet etc, and the options and input boxes offered in the related prescription scheduling GUI screen would be compatible with it. For example, laxative ‘suppositories’ are given rectally for constipation and are usually effective within 15-60 minutes following rectal dose. Here, the input box for ‘food relation’ would be absent. For each such drug preparation like a gel or a balm or a suppository or a pessary or an ointment, there is a recommended indication-wise and form-wise daily dosage range, recommended technique of administration and recommended range of frequency. But generally, there is no recommended duration range and the duration of such medications is determined as per the expected/obtained results and is to be manually inputted. Similarly, there is generally no relation of food intake. Unless specified like in suppositories or pessaries, which are usually administered at bedtime, the computing system would rather associate the application timings of ointments and creams and balms etc with other drug intake times to avoid needless botheration. The GUI screens, thus, meant for input of such medications like suppositories, gel, pessary, balms, ointments, creams, sprays, eye/ear drops etc are configured according to their characteristics. Selection of a pertinent GUI screen requires the computing system to identify the necessary inputs. The necessary inputs are drug name with/without drug form, which generally suffice to pinpoint the characteristics of a drug. Once the characteristics of a drug are pinpointed, the system could easily determine whether a subset of ‘outputs’ or the entire set of the ‘outputs’ would be needed to be displayed for auto computing and entering. The entire set of ‘outputs’ is quantity and strength of each drug dose, technique of drug administration, administration time for each drug dose, precautionary instructions, food relation, frequency of drug doses per day, and duration of administration. The determination of selection of said set or subset of said set is accomplished by the computing system using said ‘inputs’ to determine ‘a subroutine to be called’. Corresponding to said inputs and using one of the standard programming methods like ‘if-else’ or ‘switch-case’ or ‘look-up table/array’ etc, the ‘called subroutine’ determines the set or essential subset of said ‘outputs’ to be selected and displayed in the distinct GUI screen. Available types of drug forms/preparations of medications generally include tablets, capsules, elixirs, liquid orals, oral rinse, mouth wash, eye/ear drops, nasal spray, oral spray, powders, sublinguals, suppositories, gel and pessary, an antiseptic solution, topical steroidal/non-steroidal anti-inflammatory drugs, lotions and creams and balms/ointments, injections—subcutaneous or intramuscular or intravenous, infusion fluids, contrast media, dressing and appliances etc.

Once a drug name and its form are selected, a total daily drug dose is automatically computed by correlating analyzing and judging the age, weight, clinical conditions, and severity of ailment of the patient with respect to recommended indication-wise and form-wise daily dosage range and maintenance dosage range of the selected drug. The scheduler software would also automatically judge quantity and strength of each drug dose and/or each drug dose utilization time and/or technique of administration and/or food relation and/or precautionary instructions and/or the number of doses per day (frequency) and/or the number of days the drug should be taken (duration of drug administration), and would display accordingly. The scheduler software would correlate all the inputted facts about the patient, and analyze and judge the dose, frequency and duration of administration consistent with them. If the entered age indicates adult state and the ‘clinical condition’ as ‘mild infection’, and if the chosen drug is cifran (ciprofloxacin) tablet, automatically ‘1 tablet of cifran 500 mg with breakfast at 08:30 AM’ and ‘1 tablet of cifran 500 mg with dinner at 06:30 PM’ to be taken orally would be inputted. Here, the first dose may be a loading dose, wherein, instead of ‘1 tablet of cifran 500 mgs with breakfast at 08:30 AM’ in the first dose; said first dose would be 1 & ½ tablet of cifran 500 mgs with breakfast at 08:30 AM’. If ‘5 days’ duration of administration of the drug were selected, ‘to be taken for 5 successive days’ would be added. If the infection is severe, the dose of 750 milligram of cifran 2 times a day would be selected instead of 500 milligram, or the frequency of 500 mg tablet may be made 3 times a day. Similarly, the duration of administration of cifran would depend on the severity of infection and would be guided by the recommended range of duration of the drug administration. If desired, the physician may manually alter or fine-tune the automatically determined dosage, time of administration, frequency or duration of administration etc. To exemplify the recommended range of form-wise daily dosage, the recommended dosage of salbutamol (antiasthmatic) tablets in asthma is 2-4 mg 3-4 times a day in adults, while in extended release tablets, it is given 4-8 mg 2 times a day, and in aerosol form, it is given 100-200 microgram 2-4 times a day. To exemplify the recommended range of maintenance dosage range, let us consider clobazam (anticonvulsant), which is given as an adjunct for refractory epilepsy, absence seizures, myoclonic seizures etc. Initially, in children over 3 years, as an adjunct, the clobazam is given 5 mg/day and gradually increased up to a maximum of 30 mg/day followed by a maintenance dose in the range of 0.3-1 mg/kg/day. (mg=milligram, kg=kilogram, gm=gram, min=minute and ml=milliliter)

Generally the dose of tablets or capsules or injections is specified as mg/kg body weight to be taken/injected once a day or in 2 or 3 or 4 or 5 or rarely more divided doses. The dose can also be in mg/day as in clomiphene or in micrograms/day as in Vitamin D3. Or the dose may be in international units (IU) as for erythropoietin or insulin. Or it can be 2-3 drops of 1% xylometazoline to be instilled in each nostril every 8-12 hours for nasal congestion. Or it can be clotrimazole 1% w/w cream, alone or with corticosteroids, for superficial fungal infection, to be applied 2-3 times daily. This discussion is merely exemplary and the subject of dosage of medication or technique of the medication or utilization of various preparations is a very well known science and there is no need to go any further in this regard.

As the selected ‘tablet’ form (depicted as shaded box 73) is inputted in the input box 64, simultaneously, a graphical data corresponding to a symbol of a tablet is also inserted in the TSS. In the reminder device, this data would be displayed as a symbol of tablet. Quantity and strength of each drug dose, frequency per day, food relation and drug dose utilization time are automatically determined, as shown in FIG. 4 by shaded boxes 74, 75, 76, 77 respectively, by correlating, analyzing and judging said total calculated daily dose, recommended indication-wise and form-wise daily dosage range and recommended range of maintenance dosage and divided dosages per day, food guidelines, region-wise or user defined pre-programmed standard administration times, and bioavailability related pharmacokinetics of the selected drug with respect to patient related information. FIG. 4 depicts automatically determined drug dose, frequency per day, food relation and drug dose utilization time, which are inputted in input boxes 65, 66, 67 and 68 respectively. Similarly, the duration of administration is automatically determined (shown by shaded boxes 78) by correlating and analyzing the age, weight, clinical conditions, and severity of ailment of the patient, and selected drug name and its drug form with its computed dose strength and frequency of doses per day with respect to related recommended range of duration of administration, and inputted in input box 69. The recommended range of the duration of administration varies with type of illness or severity of illness. For example, the recommended range of duration of administration for ciprofloxacin varies from 5-7 days as per the severity of the disease. But if gonorrhoea were diagnosed, a single dose of 500 mg of ciprofloxacin would suffice. The programmed memory may include a preprogrammed standard default plan for drugs like ‘insulin’ wherein the duration is not limited by the ‘days’ and the ‘inputted dose and administration time’ is for ‘continual treatment’ till further instructions. In chronic clinical conditions like diabetes, the dosages of prescribed drugs have to be gradually increased or decreased as per the response to prescribed medication. The system itself will display a pop-up message requesting the user to manually enter the input boxes of dose, frequency, and duration etc for such chronic clinical conditions.

The automatically inputted dosage specifications, frequency, technique of administration, food relation, drug dose utilization time and duration of administration in active workspaces as depicted in FIG. 4, can be manually altered for fine-tuning or as per the need. The displayed drop down members for dose input, time of drug dose utilization, food relation, frequency of drug doses per day and duration of drug administration are specifically intended for facilitation of such manual alteration. Actuating control input like a select control or a scrolling control would enable a user to promptly identify and select the alteration. Other way of manual alteration would be placing a cursor in active workspaces, deleting the automatically inputted values and then inputting the desired inputs.

Medication may be instructed to be given/taken immediately (Stat). Generally ‘Stat’ is selected for drugs like aminophylline in cases of acute bronchospasm requiring rapid bronco-dilatation or adrenaline in anaphylactic shock. Or medication may be instructed to be taken once a day (OD), or 2 times a day (BD), or 3 times a day (TDS), or 4 times a day (QID) etc. The short forms like OD, BD are exemplary and any other customary short forms commonly used in a region could also be included for that region.

Food intake might interfere with drug absorption. For example, the bioavailability of terfenadine (antihistaminic) is significantly reduced when taken after food, but its plasma concentration is increased by grapefruit juice! Absorption and bioavailability of hydrochlorothiazide (diuretic) is increased with food, whereas with food, the absorption of azithromycin is reduced by 50%. Medications and their relation with timing could be programmed or preprogrammed. Medication may be taken once a day—say with breakfast, or 2 times a day (with breakfast and dinner), or 3 times a day (with breakfast, lunch, and dinner), or 4 times a day (with breakfast, lunch, dinner, and at bedtime) etc. Such set of default timings for OD or BD or TDS or QID etc and their relation with timing are exemplary and can be altered or programmed by adding user-defined ‘settings’ facility.

Furthermore, the implied meaning of each of the terms like OD or BD can be defined with respect to food intake by the user as per his/her specifications. For example OD may mean ‘with breakfast’ or ‘with lunch’. This set of correlative timings would be in application until a new set is defined. With regard to the drug administration activities, the programmed memory preferably would have region-wise or user defined pre-programmed set of timings with food relations like with food, or 1 hour or 1 & ½ hour or 2 hours ‘before’ or ‘after’ food intake. The user can define a different set of timings for each of the food related (fasting or with/before/after food) drug administration activities instead of the above-mentioned default set timings.

Such user-defined ‘settings’ facility could be added, which would function through conventional software routines. This set of timings would be in operation until a new set is defined. Besides, a user can alter the inputted default time by selecting and altering. Side effects like nausea or vomiting could be minimized if drugs are given with food. For example, ciprofloxacin is known to have no significant effect on absorption or bioavailability with food intake and could be given with food. Considering the example, wherein cifran (ciprofloxacin) 500 mg 2 times a day for 5 days is selected, then the displayed prescription format would be ‘1 tablet of cifran 500 mgs with breakfast (08:30 AM) and 1 tablet of cifran 500 mgs with dinner (6:30 PM) to be taken orally for 5 consecutive days’. Here, the programmed memory includes a preprogrammed breakfast time (08:30 AM) and the dinner time (6:30 PM). Though the timing of meals may vary from person to person, the programmed memory may have region-wise pre-programmed standard meal times (breakfast, lunch, dinner etc) during which most persons normally eat in that region. For example, the memory may include a preprogrammed standard default time for Morning (6:00 AM), Breakfast (08:30 AM), Lunch (12:30 PM), Afternoon (3:30 PM), Early evening (5:30 PM), Dinner (6:30 PM), Late evening (8:00 PM), and bed time (10:00 PM).

Instructions regarding food relationship with each associated drug dose administration is determined by correlating, analyzing and judging time of day data of region-wise or user defined food intake times, region-wise or user defined time relation regarding instruction of with, before or after food intake, and interactions with food pertaining to absorption and/or bioavailability of the selected drug and its drug form with respect to selected quantity and strength of each drug dose and frequency of drug doses per day.

The memory stores each brand name and its constituent generic name or names of the therapeutic ingredient/ingredients (generic name/names), relational information pertaining to each generic name of drug with respect to patient related information like age, gender, weight, clinical conditions, allergy, physical status, severity of ailment, and concomitant drug administration. Computational means, while facilitating a quick scheduling of a medical prescription, assists a prescriber by means of relational analysis and displays cautionary or advisory information. It retrieves generic name/names for the brand name/names of current medication and retrieves inputted patient related information from memory storage. The computational means compares the prescribed medication/medications with respect to said patient related information and automatically identifies and displays cautionary/advisory relational information if any, comprising drug interactions, safety alerts, contraindications, precautions, special directions, potential hazards, adverse side effects, food interactions, lab interference and recheck messages. To exemplify further, suppose a user has already entered an antipyretic and analgesic combination of ‘fencemol (diclofenac with paracetamol)’ and further prescribes concurrent administration of ciprofloxacin. As depicted in FIG. 6, a popped up dialogue box 94 having dotted lines would be displayed, cautioning the user that ‘CNS excitation may occur with concurrent administration of diclofenac with ciprofloxaci0n’. Or, if chloramphenicol were prescribed with cifran, then a dialogue box would display a message: ‘combination of ciprofloxacin with chloramphenicol may be antagonistic’. The programmed memory has a pre-programmed relational memory therein for alerting the user. Therefore, if cetirizine (antihistaminic) were prescribed, which may cause drowsiness as a side effect, a warning (precautionary instruction) would be included in the prescription content, stating: ‘a job requiring mental alertness like driving or operating on heavy machinery should be avoided’. Once a drug name entry is completed, the program memory has pre-programmed relational memory therein for judging in terms of efficacy, wherein, interactions between concomitant medications like additive or synergistic or antagonistic action are identified and displayed. Similarly, if precautions or contraindications or drug interactions are identified, they are automatically displayed to the prescriber for his/her discretion. For example, piperazine (anthelmintic) may potentiate extrapyramidal effect of chlorpromazine and other phenothiazines (antipsychotics). Lincomycin has synergistic effect with clindamycin and erythromycin. Gentamicin and kanamycin can cause ototoxicity and nephrotoxicity. Pyrantel pamoate (anthelmintic) may antagonize anti-ascaris activity of piperazine. Minocycline and doxycycline (antibacterials) are contraindicated (forbidden) in pregnancy and lactation. Bromhexine or carbocisteine (adjuvents) are mucolytic and improve penetration of amoxycillin. By inhibiting beta lactamases, clavulanate makes beta lactamase producing strains of staph, E. coli, proteus, klebsiella etc susceptible to amoxycillin. Concurrent administration of amoxycillin and cloxacillin, or amikacin and penicillin are more effective against the susceptible bacteria. Lab test interference may occur with cefotaxime therapy, which gives false positive urine glucose, or propranalol may interfere with bilirubin measurement.

If the scheduling of a selected drug, accomplished by the computing means (or manually altered), were acceptable, the user would just have to click the ADD button 79. Once the ADD button is clicked, the entire prescription for the currently entered drug name would be entered in the prescription content box 91. FIG. 5 depicts currently entered diclopar and cifran tablets. A follow-up assessment date may be included in the prescription content. In the lower portion of FIG. 5, there are conventional customary buttons like ADD, REMOVE, DELETE, ENTER, BACK, HELP, SAVE, and NEXT. Additional REQUEST button is for requesting pathological tests or X rays or physiotherapy etc, and MISC button is for inputting miscellaneous prescription/instruction like compounding pharmacy products. In lower portion of the GUI screen for scheduling a medical prescription and prescription content screen, as depicted in FIG. 4, 81 and FIG. 5, 93, a small zone is reserved for advertisements.

An exemplary scheme is presented hereinbelow to demonstrate one of the possible ways of computation for quantity and strength of each dosage, frequency of dosages per day, and duration of administration of the selected drug. This algorithm is for the purpose of illustration only.

1) Check whether the selected drug is forbidden according to patient's age, weight, associated clinical conditions, severity of ailment, and allergy.
2) Check compatibility with concurrent drug administration.
3) If not contraindicated, determine the technique of drug administration as per the inputted drug name and drug form.
4) If no major adverse effects or contraindications then compute the total daily dose, each dose (dosage), frequency of doses per day, and duration of administration as per the constraints described hereinbelow.
5) Modify the dosage as per the ‘age’ related constraints:
A) Minimal allowable age: Many drugs are given with caution or not recommended or contra-indicated below certain age. For example, oxazepam (anxiolytic) is contraindicated below 6 years of age. Diclofenac (anti-inflammatory) is not recommended below 18 years of age.
B) Age wise modification: A lot of drug doses vary as per the age of the patient. For example in case of diisopyramide (antiarrhythmic): Under 1 year=10-30 mg/kg/day, 1-4 years=10-20 mg/kg/day, 4-12 years=10-20 mg/kg/day, 12-18 years=10-20 mg/kg/day, adults=100-150 mg 4 times a day, renal/hepatic impairment=6-15 mg/kg/day.
C) Elderly: A lower dose, generally half of the adult dose, is advocated. For example, for enalapril (antihypertensive), the adult dose is 5 mg/day, while in elderly; the dose is started at 2.5 mg/day and slowly built up as needed.
6) Modify the dosage as per ‘weight’ related constraints:
Weight-wise dosage: A lot of drugs are given as mg/kg/day in single or divided doses. For example, Gentamycin (antibiotic) is generally given in adults as 1 mg/kg body weight 3 times a day. In serious infection: 1.7 mg/kg body weight 3-4 times a day. In premature babies and neonates up to 1^{st} week: 2.5 mg/kg body weight 2 times a day. In neonates and infants, it is given as: 2.5 mg/kg body weight 2 times a day. Children up to 10 years: 2-2.5 mg/kg body weight 3 times a day. Children above 10 years: 1.5 mg/kg body weight 3 times a day.
7) Modify as per the constraints related to ‘clinical conditions’:
a) Many a times, the dosage varies with clinical conditions. For example, in case of propranolol (beta blocker):
Hypertension=10-40 mg propranolol 3 or 4 ties a day.
Post myocardial infarction=180-240 mg propranolol in divided doses.
Hypertrophic cardiomyopathy=20-40 mg propranolol 3 or 4 times a day.
Essential tremor=40 mg propranolol 2 times a day. Increase slowly up to 240-320 mg/day in divided doses.
Pheochromocytoma=Propranolol is given with alpha blocker. Propranolol is given as 30 mg/day in divided doses.
b) In cases of renal impairment and hepatic impairment, many drugs are not recommended or are given with caution or given with reduced dosage. For example, in case of tobramycin, adult dose is 3 mg/kg/day in 3 divided doses. In case of renal impairment, the loading dose of tobramycin is 1 mg/kg is followed by either normal dose divided by serum creatinine value or normal dose given at intervals obtained by multiplying serum creatinine value by 6.

In case of bezafibrate (hypolipidaemic), adult dose is 200 mg 3 times a day (after meals). While in renal impairment, the dose is defined by serum creatinine level as given in the table hereinbelow.

| Serum creatinine | | bezafibrate dose |
|---|---|---|
| 1.5 | mg % | 200 mg 3 times a day |
| 1.6-2.5 | mg % | 200 mg 2 times a day |
| 2.6-6 | mg % | 200 mg once a day or on alternate day. |

Or in renal impairment, a rough guide in calculating the dose in stable patients is to divide the normal dose by the patient's serum creatinine level or the dose is adjusted by the value of creatinine clearance.

Adult dose of ‘ampicillin+sulbactam’ is 0.5-1 gm of sulbactam+1.2 gm ampicillin 4 times a day.

### In Renal Impairment:

| | |
|---|---|
| creatinine clearance = 30 ml/min | 0.5 gm sulbactam + 1 gm |
| | ampicillin 4 times a day. |
| creatinine clearance = 15-29 ml/min | 0.5 gm sulbactam + 1 gm |
| | ampicillin 2 times a day. |
| creatinine clearance = 5-14 ml/min | 0.5 gm sulbactam + 1 gm |
| | ampicillin one time a day. |

Or in renal impairment or in hepatic impairment or in elderly patients, a rough guide in deciding the dose in stable patients is half the normal dose.

c) Modification as per the severity of the disease: Many a time the doses of drugs depend on the severity of the infection. The dose of ampicillin, a broad-spectrum antibiotic, is recommended as 250-500 mg to be given 4 times a day. The selection of each dose is to be chosen from given range of 250 to 500 mg as per the status of the infection. For mild infection, one can choose 250 mg 4 times a day, while in case of severe infection the dose would be 500 mg 4 times a day.
d) In certain physiological conditions like pregnancy or lactation, a lot of drugs are given with caution or not recommended or contraindicated.
e) In cases of chronic clinical conditions like diabetes or hypertension, doses of related drugs are gradually increased (modified) and monitored as per the response of the drug dose. For example, gliclazide (antidiabetic) is given 40 to 80 mg/day and slowly increased up to 320 mg/day in divided doses (gliclazide is generally given before breakfast and evening meal).
8) Rarely, the dose of a drug varies with gender. For example, in infertility, clomiphene is given in female as ovulation inducer, and in male, it is given for oligospermia. The dose in female is 50 mg/day starting on the 5^{th} day of the cycle and increased up to 200 mg/day, while in male, the dose is 25 mg/day for 25 days and repeated after 5 days interval.
9) Drug-form wise drug dosage: Any drug will have specific therapeutic actions, indications, and recommended indication-wise and form-wise dosage. For example, isosorbide is given in angina to increase the blood flow to ischemic regions of heart. It is given as a dose of 20-40 mg to be given 2 or 3 times a day. While a single 40 mg sustainable release tablet of isosorbide (a different form of isosorbide) in the morning would suffice.
10) Indication wise dosage: Metronidazol (antiprotozoal and antibacterial) could be used as 400-800 mg tablets, 3 times a day, for 5-10 days for amoebiasis; while 15 mg/kg (injectable-intravenous) is infused over 1 hour followed by 7.5 mg/kg infused every 6 hours for anaerobic infections.
11) Synergistic/potentiating effect: With concurrent medications, if synergistic or potentiating or additive effects exist, the dosage, if required, is modified. The dose is reduced/adjusted judiciously. Fuzzy logic, based on statistical data, may be used to implement the addition/subtraction of a dither as described hereafter. When synergistic or potentiating or additive effects exist, manual modification to a computed dosage would have to be done. Such modifications to the determined dosage are generally done by adding or subtracting an arbitrary but small value called as a dither value. Basically, one performs a sort of fine-tuning of the dosage. Such modifications are noted down by the scheduler software as modification history and stored in the memory. The dither value may be determined on available statistical data of the manual modification history.
12) Relation to food: Drug intake time of each dose of each medication is computed as per the region-wise or user defined food intake times, region-wise or user defined time relation regarding instruction of with, before or after food intake, and interactions with food pertaining to absorption and/or bioavailability of the selected drug.
13) Relational analysis: Cautionary/advisory relational information comprising drug interactions, safety alerts, contraindications, precautions, potential hazards, adverse effects, food interactions and lab interference is identified and displayed.
14) Calculation of the total daily dose is carried out as per the age, weight, associated clinical conditions and severity of ailment of the patient with respect to the recommended range of indication-wise and form-wise dosage and recommended range of maintenance dosage of the selected drug.
15) Determine the number of units like tablets/capsules per day:
Divide the total daily dose by the strength of the requisite unit or if needed by smallest available unit. Using the ceiling function or flooring function, calculate the total number of units/day.
16) The frequency of dosages per day is determined as per the recommended range of divided dosages per day, duration of systemic bioavailability, activity, metabolism and elimination of the selected drug, calculated total daily dose and calculated total number of units/day.
17) The duration of drug administration is determined as per the age, weight, associated clinical conditions and severity of ailment of the patient with respect to recommended range of duration of drug administration.

### Calculation of Dosage:

One of the possible methods, as an example, is described hereinbelow.

Suppose ‘amoxycillin’ is to be given for a patient of Age=8 years (pediatric age group), Weight=17 kilograms, Clinical condition=severe upper respiratory tract infection.
The constraints: 1) Pediatric age group. 2) Under 20 kg. 3) Severe infection. The range of the dose of amoxycillin in children under 20 kg is 20-40 mg/kg/day in 3 divided doses. In other words, for pediatric patients, under 20 kilograms body weight, the dose of amoxycillin is 20-40 milligrams per kilogram body weight per day. Severe infection indicates a higher side of the dose. Hence, 40 mg per kg body weight would be advocated in the present case.

### Dosage Calculation:

Step 1. Total daily dose: 17×40 mg of amoxycillin=680 milligrams/day is the total daily dose of amoxycillin, where 17 is weight in kg.
Step 2. Considering the fact that the available units or formulations of amoxycillin is 125 mg tablet, or 125 mg in 5 ml of syrup,

$$To determine the number of units / day \text{:}$$

$$Divide the total dose by the strength of the smallest available unit = \frac{680 ( total dose in mg )}{125 ( smallest available unit in mg )} = 5.44$$

Now, using the ‘ceiling function’,
we have ┌5.44┐=6
and
using the ‘flooring function’,
we have └5.44┘=5
For the higher side of the dose, the flooring function would be prudent and for the lower side of the dose, the ceiling function would be sensible. Hence, using the flooring function in the present case, total of five tablets of 125 mg (or five measures of 5 ml of syrup) would be given per day. Here, Dutch rounding or statistician's rounding may also be applied instead of ceiling or flooring function.
Recommended range of divided dosages: Amoxycillin is generally given 8 hourly (in three divided doses). Bioavailability: Peak serum concentrations of amoxycillin are usually attained within 1 to 2 hours following oral administration. Its elimination half life is about 1 to 1 & ½ hours. Furthermore, food intake has no effect on absorption or bioavailability of amoxycillin and is given without regard to food intake. Considering the above-mentioned facts, 5 units of amoxycillin would have to be arbitrarily divided into 2, 1, and 2 units and given in morning (06:00 AM), afternoon (03:30 PM) and bedtime (10:00 PM) respectively. The recommended range of duration of amoxycillin administration in respiratory tract infection is 5-10 days. Infection being severe, the treatment should be given for 10 days in present case. (Furthermore, it is advisable to continue the treatment for at least 3 days after the symptomatic relief.). The recommended range of duration of amoxycillin administration varies from 1 to 14 days as per different etiologies: otitis media (children)=3-10 days, gonorrhoea=a single dose of 3 grams, H. pylori infection with peptic ulcer=7 days (with triple regimen), infective endocarditis=14 days as a follow up treatment subsequent to penicillin and gentamycin therapy.

Requests for Pathology Laboratory or Radiology or Physiotherapy:

A patient may present with peculiar signs and symptoms where differential diagnosis would need various tests. For example, a patient with long standing ‘pyrexia of unknown origin’ would need total white blood cell count to find out leucocytosis or leucopenia, and differential count to detect neutrophilia or neutropenia or lymphocytosis etc, Widal test to rule out enteric fever, erythrocyte sedimentation rate to check for hidden inflammation, and bone marrow studies to rule out aleukemic leukemia, and X ray chest to rule out tuberculosis. Thus a doctor needs to have pathology and radiology reports for reaching to a diagnosis. Subsequent to clicking ‘REQUEST’ on the prescription scheduling or prescription content GUI screen, the ensuing window would preferably display Request GUI screen. For requesting a pathology test or a radiology procedure or a physiotherapy procedure, generally a request form is supplied, which contains all the available tests in pathology, facilities for radiodianostic procedures and physiotherapies. Such lists are well known and quite often supplied by pathology or radiology departments or by physiotherapists. A user is needed just to tick mark the required tests or X-rays. In a comparable way, a displayed request GUI screen would facilitate a user to request the desired tests/procedures by providing entire list of available pathology tests or radiology/radiodiagnosis procedures or physiotherapy procedures. A user just needs to select the required tests/procedures from the provided list. Or in another embodiment, a request GUI screen provides for selection and entering a request, wherein input of the name of the required test/procedure is facilitated. For example, a test/procedure input box could be actuated by sequential input of initial letters of intended name of a test or a procedure, wherein, in response to received partial text entry, a drop down list of plurality of completion candidates would be obtained and displayed. The narrowing criteria would be associated with each successive sequential input or by actuating scrolling means. This would enable a user to identify and select the intended name. The selected test/procedure would then be entered automatically. Still another way of entering the required test/procedure would be to select criteria, which in turn would display a drop down menu of pathology tests, radiology procedures or physiotherapy procedures for selection. In the event of selection of ‘pathology test’, a drop down list of headings of its classification like clinical pathology, chemical pathology, hematology, histopathology, microbiology, serology etc would be displayed. Selection of a heading would display tests under said classification. For example, if hematology were selected, tests like hemoglobin, total and differential white blood cell count, total red blood cell count, platelet count, packed cell volume, bleeding and clotting time, prothrombin time etc would be displayed to select and enter. Similarly for the procedures of radiology, radiodiagnosis and physiotherapy, analogous drop down lists would be presented for selection. A request for radiology/radiodiagnosis may be for X ray or for sonography or magnetic resonance imaging (MRI) or computerized axial tomography (CT scan) or special techniques like pyelography or barium studies or angiography or eco-cardiogram etc. Similarly, a patient may need physiotherapy, which includes various procedures of physiotherapy, occupational therapy, rehabilitation, podiatry, palliative care and speech and language therapy.

A patient may present with peculiar needs requiring compounded tablets or capsules or liquid orals. Compounding pharmacy is a process of mixing drugs by a pharmacist/physician to fit the patient's specific needs. Compounded medications are approved drugs, and pharmacies dispensing them follow a doctor's prescription. This allows a prescribing physician to tailor a prescription as per the special need. For example, infants may need a very small dose or dysphagic patients may need to change the form of the medication from a solid pill to a liquid or patients suffering from menopausal symptoms may need bioidentical hormones. For inputting such formulations or for inputting any extra note or instruction, a miscellaneous input request button (MISC) is provided which upon activation would display an input box or page. User can enter the data or instructions or note by usual text entry or may be facilitated by predictive typing. The inputted text may be appended to the prescription content or printed on a separate page as per user's instructions. Similar to some smart C/C++ editors, the user can straight away select ‘predictive typing’ and type compounded medications or instructions without the need of having an elaborate GUI screen. The theme of this mode would be as if he/she were writing a normal prescription and the application software would just help in a smart way. In predicative typing, the application software compares the entered initial letter/letters sequence (input string) with the stored array of related expressive forms to find a matching choice. Expressive forms are selected as per the input string and from the choices of completion candidates offered in the data sets. Said choices are offered according to the frequency-of-use or common usage (statistical probabilities) and the peculiar placement in the text. If only a single matching expressive form is found, the application software fills in the remainder of the letters/words. If more than one matching expressive forms is found the user is allowed to select the desired expressive form from the list of completion candidates. Furthermore, for an input string, the application software would also refer to the learnt information, wherein the current acceptance of the candidates for input string defines the learning process. The history of the input strings and related inputting processes is stored as learned information. When a predicting portion is partially matching or has multiple probabilities, prediction of the expressive form for an input string could be performed according to the learnt information.

A peculiar problem may arise in a multiethnic country like United States when a consulting physician is English speaking and the patient is a Hispanic or a Vietnamese or an Indian who understands very little English. Naturally, being English speaking, the physician would prescribe in English. However, despite the prescriber being English speaking and the prescription inputted in English, if the display in the reminder device displays in the language of the patient, then the compliance would be more successful. As an illustration, one of the possible methods is described. For switching a language, the scheduler device stores relational data for several languages, wherein relation corresponds to a table having rows and columns. Columns n₁, n₂, . . . , nₚ correspond to languages like English, Spanish, German, Vietnamese etc. And rows m₁, m₂, . . . , m_{q} correspond to text element/elements like tablet, capsule, ‘2’, 500 mg, and precautionary instruction like ‘do not drive’ etc. Suppose n₁ represents English, n₂ represents Spanish, n₃ represents German, and m₁ represents ointment, m₂ represents tablet, and m₃ represents ‘do not drive’. In that case, n₁m₁ would represent ‘ointment’ (in English), n₂ m₁ would represent unguento (Spanish for ‘ointment’), and n₃ ml would represent salbe (German for ‘ointment’). For switching the text element/elements of said scheduled prescription display data stored in prescriber's language (first language) to a patient's language (second language), each text element/elements representing a first language is switched to corresponding text element/elements representing a second language equivalent in meaning to said first text element/elements. The prescriber instructs such a switch. While updating the TSS, the application software of scheduler device inputs the scheduled prescription display data in the language of the patient. The desired language for switch could be selected by the user while formulating the prescription or it could be implied by the patient related information. Alternatively, translation software can also be embedded while forming the FSMP, which would perform the translation operation in the reminder device as per the language settings in that device. The reminding device would also need to have facility to display in the language of the patient. The herein above mentioned multiple language support can also be applied for voice.

FIGS. 7 A and 7 B illustrate a flowchart of the sequence of steps pertaining to the process of facilitated inputting of medication. Step 111 depicts the start, and progression begins at step 112, wherein, the patient information GUI screen is displayed, and at step 113, said patient information is inputted. At step 114, the prescription scheduling GUI screen is displayed, and at step 115, using drug name selection procedure, operations for inputting the intended drug name are performed and TSS is updated for that drug name. The decision diamond 116 checks whether more than one forms like tablet, capsule, liquid oral etc are available for the selected drug name. If ‘yes’, then at step 117, the respective forms of the selected drug are displayed and the desired drug-form is manually selected and inputted, or if ‘no’, then at step 1118, the only available drug-form is automatically selected and inputted and TSS is updated for that drug form. Once the drug form is selected, then at step 119, GUI screen displaying said subset of outputs or said entire set of outputs as per the drug name and/or drug-form is automatically selected, the related values of outputs are computed and inputted and accordingly displayed, and TSS is updated. The decision diamond 121 checks whether the ADD button is clicked. If ‘no’, then the system allows the manual modifications of computed values of outputs to be made at step 120 and then goes to step 121. If ‘yes’, then the system checks (decision diamond 122) whether any more drug name is being entered in the MEB of the scheduler screen, which would have been reset after ADD is clicked. If yes, then go to step 115, wherein the user elects to input another drug name. If no, then as depicted in FIG. 7 B, which is continuation of the flow chart of FIG. 7 A, the system checks whether REQUEST button is clicked (decision diamond 123). If yes, then at step 124, the request entering GUI screen would be displayed for inputting pathological tests, or radiological or physiotherapy procedures. Once the required request/requests are inputted, the system goes to step 125. If REQUEST is not clicked, then the system goes to decision diamond 125 to check whether MISC button is clicked. If the MISC is clicked, then the system displays miscellaneous text box or screen (step 126) for inputting miscellaneous input and allows the user to input miscellaneous text. When the prescription creation process ends as per the user instruction, the prescription contents with request data if any and miscellaneous data if any is displayed (step 127). At step 128 the scheduling of the medical prescription ends. The term ‘scheduled medical prescription’ (SMP) indicates a fully formulated conventional prescription comprising the date, prescribing doctor related and patient related information, and details of prescribed drugs, wherein each drug name is generally associated with the drug form and/or quantity and strength of each drug dose and/or frequency of drug doses per day and/or time of each dose administration and/or technique of drug administration and/or food relation and/or precautionary instructions and/or duration of administration of the prescribed drug. It may also include a prescription for compounded pharmacy product/s or a request for test/tests for pathology and/or procedure/procedures for radiology and/or physiotherapy.

A user can also carry out the scheduling by manual operations. In manual mode, a drug name is selected similar to auto mode. Once a drug name is selected, available drug forms for that brand name would be displayed for selection. Once a drug form, say a tablet form is selected, automatically, a drop down list of available options for the tablet of that drug like a tablet of 250, 500 and 750 milligrams would be automatically offered, allowing a user to select a desired drug dose. Once the drug dose is selected, automatically, the drop down list would instantly ask whether STAT, OD (once a day), BD (two times a day), TDS (three times a day), QID (four times a day), ‘[--] times a day etc, allowing a user to select a desired drug frequency. Or said list would depict the recommended range of divided doses for the selected drug like BD and TDS to choose from. Other inputs like time of day for each dose administration, food relation, precautionary instructions and duration of administration would be similarly facilitated for entering. Thus, even in manual mode, the system assists a user by providing a related menu to choose from. In cases of chronic clinical conditions like hypertension or diabetes, the manual mode for scheduling a prescription would be preferred since such conditions do not have a deterministic way of computing a dosage, frequency or duration of administration. Here, the dosages of prescribed drugs have to be gradually increased or decreased as per the response. Even in auto mode, the system itself will display a pop-up message requesting the user to manually enter the input boxes of dose, frequency, and duration etc for such chronic clinical conditions.

The GUI screens of the SD include a customized appearance, wherein, a principal/larger zone (Preferably 75 to 85%) represents the prescription-scheduling template, and a secondary/smaller-area (for example, FIG. 4, number 81) stands for display of an advertisement (ad). The ads in the ad zone 81 may preferably be related to the selected drug like ‘cifran’. Or the advertisements may also be related to the entered clinical conditions like hypertension or diabetes. As a prescriber inputs a brand/generic name (a prescription drug) in the medicine input box, a sponsor related ad about the ingredient generic name/names of that drug would appear in the ad zone. That way a doctor could be hammered-into or impressed-upon with the sponsor related product. Thus the ads would function like a virtual medical representative, each time visiting a doctor when a new drug name is entered in the scheduler screen. The ads may preferably occupy the lower section of the screen horizontally or side portions vertically. For example, if diabetes were entered as one of the clinical conditions, the ad area would display sponsored advertisement of ‘glicleze’, a gliclazide tablet of 80 mg produced by ‘Rizon’ (sponsoring company) assuring a comprehensive diabetic care. The user may just click the displayed drug name in the ad zone for replacing the entered drug name. The instant a new drug name is entered in the MEB; the displayed ad would naturally be related to that drug or ingredient drugs. The ad space may have a single display field or multiple smaller fields in the same locale. Each or any of the ad field may have a single or multiple sponsors permanently or temporarily associated with it. Generally in case of temporary association, an ad is related to a clinical condition and/or a drug name input. In case of permanent association, the ad may or may not be related to a clinical condition and/or a drug name input and may display any company specific medicinal/surgical/diagnostic product or a company specific ad/symbol/logo. Different types of layouts and graphics are possible and could present diverse settings of functional space and ad-space. Thus, in addition to facilitating a doctor in scheduling a medical prescription, the present invention includes a method of promoting products as well. It implies that a means for generating revenues is included by setting aside advertising space for the eternally hungry pharmaceutical companies.

In yet another embodiment, the SD may include a customized appearance, wherein, a principal zone represents the prescription-scheduling template, and one or more floating windows would be assigned for advertisements. Such floating windows, in a programmed fashion, would display various ads/sponsor-information in a user friendly way. In yet another embodiment, the ad zone may be absent, and instead, a pop-up window with the ad would be displayed. Such floating windows or pop-ups or ad zones may also contain a uniform resource locator (URL) Internet website/address for linking the user to the respective web site via an Internet connection. Various other fields, similar to advertisement, may include ‘tips’, ‘FAQs’, ‘Updates or News’ and ‘notifications’ for enhanced usage.

FIG. 8 depicts a flowchart of the software routines, wherein the system controls various inputs or displays retrieved search queries or executes relational analysis and displays related information or outputs linked data. Step 141 depicts the start, and progression begins at step 142, wherein, the system is initialized. At step 143, input fields (I/P fields) and controls are displayed in the presented window for inputting patient related data. In step 144, the central processing unit accepts the entered patient related data and stores it in the memory. At software block 145, drug input fields, designed for inputting a drug name are displayed, wherein inputting/clicking/selection occurs through a pointing device. The central processing unit determines the clicked key event and implements in accordance with it. Once user defined operations for inputting the intended drug name is performed, at software block 146, the CPU accepts the inputted drug name. At software block 147, a drop down list of related drug forms is displayed for selection. The application software performs relational analysis, and if needed, dialogue boxes enclosing cautionary advices are displayed. Once the drug form is selected, at step 148, the CPU automatically selects each dose for that drug and/or frequency and/or food relation and/or precautionary instructions and/or time of day of each drug dose and/or technique of dug administration and/or the number of days the medication should be administered as appropriate for that selected drug and in accordance with the inputted age, sex, weight, severity of ailments, clinical conditions. If the user intends to alter or fine-tune the computed medication, the CPU accepts the manual inputs. The decision diamond 149 checks if any more drugs are to be inputted. If ‘yes’, then the process goes to step 145, where the system accepts another drug name being entered in the MEB of the scheduler screen, which would have been reset after ADD is clicked. And if ‘no’, that is when ENTER button is clicked, the process goes to software block 150. At step 150, the CPU generates the scheduled medical prescription (SMP), which contains the entire detailed currently scheduled prescription as depicted in FIG. 5. At software block 151, the CPU generates a formatted SMP (FSMP) and stores it for future transmission to a reminder device. At step 151, the SMP is also stored for transmission to a pharmacy or to a database or to a printer or to a computing device. At step 154, a transmittable format of the FSMP and SMP are generated. At step 155, the transmittable format of the FSMP is sent to a reminder device, or the transmittable format of the SMP is sent to a pharmacy or a database or a computing device by the transmission unit through transmission port via communication media. Steps 152 and 153 depict supplementary actions like printing task and downloading task respectively that can be executed through relevant ports. At step 156, the function ends.

The text and symbol section (TSS) is updated simultaneously while creation of a prescription. For each inputted/deleted entry related to the medication, a corresponding text/symbol data and time of day data is inserted/removed respectively. Scheduled prescription data (programmed dosage schedule) is data, which includes scheduled prescription display data, and scheduled prescription time data. For example, consider a case, wherein a patient is instructed to take 2 tablets of malirid (primaquine 7.5 mg) at 12:30 PM (after lunch) for 15 days for terminal prophylaxis after leaving an endemic area of malaria. When the drug ‘malarid’ is inputted, said drug name ‘malarid’ is inserted as text in the TSS. In the reminder device, this data would be displayed as a text ‘malarid’. Similarly, as a ‘tablet’ is chosen as a drug form, graphical data corresponding to symbol of a tablet (or text ‘tablet’) is inserted in the TSS. In reminder device, this data would be displayed as a symbol of tablet. When a user is instructed to take 2 tablets, an instruction to display numeric ‘2’ preceding said symbol or two symbols of tablets are inserted in the TSS. Thus for each inputted entry related to each dose of each medication comprising name and/or form and/or dose and/or technique of administration and/or food relation and/or precautionary instructions, concurrently a corresponding ‘scheduled prescription display data’ comprising text and/or symbol data is inputted in TSS, which represents the graphic data for display in the reminder device. Said data for display may be textual data of name of drug, or textual or symbolic data for tablet or capsule or eye drops or creams etc, or textual data for dosage strength or precautionary instructions, or textual or symbolic data for technique of administration. Similarly, the time of day data associated with each dose of each medication is obtained and stored in TSS along with the time related data associated with duration of administration for each medication, which comprises ‘scheduled prescription time data’ that identifies each drug utilization time in hours and minutes with AM/PM, or hours, minutes, year, month, date with/without AM/PM and/or day. The CPU, with logic-based program including CPU-executable code loaded in memory, selects and extracts scheduled prescription time data and scheduled prescription display data from TSS and memory to form a scheduler file and processes it for formatting. The CPU generates an input scheduler-file (formatted SMP) by combining the content data and related metadata. The content data naturally includes the scheduled prescription data comprising ‘scheduled prescription display data and scheduled prescription time data’ and may also be attached or embedded with application programs applicable in the recipient reminder device. Said application programs comprise alarm/display related instructions compliant with said reminder device for audiovisual reminding at each drug utilizing time for the related dose/doses of medication. The metadata facilitates compatibility between scheduler and reminder device hardware/software and comprises information and/or instructions regarding the content data. Formatting module of SD comprises the CPU, memory and CPU-executable code loaded in the memory. The formatting software instructions can also specify the location of the text/icons/symbols on display screen of reminder device by preset location specifications. Overlay/formatting software may instruct to add or modify certain parameters related to display or audio or any such representation related feature. It may append, affix, supplement or add certain other parameters like sounding an alarm and/or generating vibrations and/or broadcasting an audio message and/or generating a visual display at each drug utilizing time. A software routine may be appended, which includes protocol specific data like instructions to coordinate prescription schedule, RTC, alarm system and display of the RD, and instructions for various modes of alarm like ringing, vibration, audio etc. The scheduler file is created in conformity with alarm/display related format instructions. The relationships of alarm/display related format instructions are defined with the time specifying data, specified by each medication time. The data format will be a standard format analogous to mp3 in case of audio, or jpeg in case of picture etc. If a single device acts both as scheduler as well as reminding device, then the formatted SMP (FSMP) consisting of scheduled prescription data can be used for reminding purpose in the same device that performs the scheduler functionality. Or FSMP may be transmitted to another device that performs the reminding function. When required to be transmitted, the FSMP file can be extracted and directed to specific user/formatting software as an input file. The CPU, memory, and CPU-executable code loaded in the memory would format the FSMP in the transmission format. The protocol specific data file thus prepared is handed over to data link/software, which then reframes it in a format suitable to actual physical software file of transmission. The user may specify format instructions via an input device. The FSMP and its transmittable format are prepared such that they are compliant with the recipient device and/or are compliant with said device's SMP reminder application program. This is accomplished by defining the parameters to be used by the application process in generating a formatted input file. This transmission formatted FSMP is then ready for transmission. Communication means has an execution flow that can handle various processes, formats, transformations, and conditional logic, and routes/transmits electronic data transmissions of formatted SMP to end users through wireless or wire-lined transmission or through networks with an appropriate networking protocol. Said communication means transmits the FSMP to a reminder device (RD) or transmits the SMP to the desired elements like a printer or a pharmacy or a database or a computing means. Alternatively, the formatted SMP file can be downloaded to a RD or on a storage medium like flash card or SIM card to be used by a RD. Then again, instead of TSS data, one can have raw data regarding the medication specifications. Such raw data is typically useful when there are output means in the RD like audio. Preferably a copy of the SMP is stored in the patient's file for future reference and the same file can be imported/exported from/to other patient data management or insurance related or health related database/software.

As will be appreciated by one of skill in the art, the scheduling aspect (scheduler function) of the present invention could be embodied as a method or a dedicated scheduling device or an integrated device or a data processing system or a computer program product and accordingly, the present invention may take the form of an entirely hardware embodiment, an entirely software embodiment or an embodiment combining software and hardware aspects. Or said scheduling aspect may take the form of a computer program product on a computer-usable storage medium having computer-usable program code means embodied in the medium. Any suitable computer readable medium may be utilized including hard disks, CD-ROMs, optical storage devices, magnetic storage devices, or computer memory. The computer program product/software of scheduling aspect could reside as well as run on the same computing system or it may reside in one and run on another computing system or it may reside and run in the same computing means but used from another. Such method of usage from remote computing means may be realised by means like internet, intranet or any other interconnection systems. The usage may be accomplished with the aid of scripts or servers. The scheduler function may also be implemented on an existing computer system. For example, a physician would be able to install the executable software program on the existing computer system and add the appropriate peripheral devices like a transmission module to form the SD of the present invention. Such configuration is merely an example that implements one of the embodiments of the invention, and that various other configurations can be employed so long as they permit application of the invention. For example, a drive for a CD-ROM (Compact Disk Read Only Memory) or a DVD-ROM (Digital Versatile Disc Read Only Memory) or a Universal Serial Bus (USB) flash memory may be provided through an interface such as an ATA (advanced technology attachment). The scheduler function may be stored on magnetic tape or a floppy disc or a pen drive. It can also be stored on other media such as writeable compact discs, digital versatile discs, zip drives, USB flash drives etc. Or it may utilize an optical disc. The optical disc may be a CD or a DVD. Or an optical magnetic disc, a flexible disc or the like may be used instead of the optical disc.

Transmission of data is a very well known art. Any suitable known technology can be employed for transmission of FSMP file. One of the possible ways of transmission is described hereinafter as an illustrative example only. A user, using the scheduler device, can command the transmission of the FSMP file to a remote receiving reminder device. The transmission process of FSMP comprises of the following intermediate processes: The user commands transmission of FSMP file to a reminder device specified by its unique number, email address, web-address, hardware address etc. The CPU detects the said command and retrieves the FSMP. The CPU invokes communication interface, which is a combination of hardware like communication ports (like USB, Ethernet etc), modem, antenna etc, and software like socket communication drivers, transmission control protocol/internet protocol stack, bluetooth stack etc. Said communication interface converts the data of the FSMP file into a signal format specific to communication media and protocol by putting additional data fields like preamble, header, trailer, sender and receiver node addresses or identifiers, error correction bits etc to form data frames. The communication media establishes connection with said receiving device either directly or indirectly through any one or combination of inter connecting networks like local area network, wide area network, public switched telephone network, internet, intranet, GSM, CDMA etc through servers, routers etc. Said communication interface sends the data frames on the physical media like optic-fiber, wired media, wireless media etc in the form of analog or digital as per the specification of the physical media.

Upon transmission of the FSMP file to the intended receiver like a receiving reminder device, a suitable notification like ringing, vibration or pop-up message would take place to indicate the user about an outstanding reception. Upon approval and request by the user to accept the reception, a similar communication interface as described hereinabove functions in the receiving device in a similar way so as to facilitate the reception and to extract the scheduler file from the received data frames. Optionally, an acknowledgement may be sent back to the transmitting device to notify the success/failure status of reception if any. Furthermore, a scheduled medical prescription can be specially formatted for transmission to a pharmacy or printer or data storage or server or a computer, and transmitted accordingly.

A reminding device preferably consists of a reminding feature (reminding functionality) that comprises receiving means for receiving a formatted scheduled medical prescription and reminding means for precisely reminding each dose of each prescribed medication till acknowledged. The reminding alarm function is implemented at each drug utilizing time and related text/symbol data is displayed for the drug dose/doses to be administered at that instant. Said reminding feature is of conceivable utility when integrated with small and commonly used electronic devices like portable telephones or cell phones or hand held computing devices. Such devices are not only becoming increasingly trendy but are also turning into a need even for a common man.

An electronic computing device capable of performing reminding functionality is a reminder device (RD). An electronic computing device, if devoid of reminding functionality and which is upgradeable with the hardware and/or software pertaining to the reminding feature, and which is upgraded and made compatible with receiving the FSMP and executing the reminding function according to the received scheduled prescription data, is hereafter called as integrated reminder device (IRD). The process of upgradation is termed as integration. Said reminding feature could preferably be integrated in a portable telephone like a cellular/mobile phone or a personal handy phone or a car telephone or a telephone or hand-held devices such as personal digital assistants or palmtop computers or digital diaries or personal computers. Or said reminding feature could be integrated in a smart phone or a maritime mobile radiotelephone or a pager or the likes, or wrist-worn devices, or a timepiece or a wristwatch, or laptops or computers or interactive phone devices, or household appliances, or televisions, or television set top boxes, or other computers and the like or other devices capable of bearing and implementing the reminding application. The devices selected for integration are selected on the basis that said devices already incorporate various functional units more or less capable to receive the transmitted FSMP and more or less capable to execute the reminding function. Instead of incorporating the reminding feature in a hand held computing device, a tiny independent dedicated reminder device (DRD) can be configured such that it can be clipped to a pocket or kept in a purse or worn on the body. Though apparently dissimilar, IRD and DRD would efficiently execute the reminding function till acknowledgment and therefore henceforth called as reminder device (RD). FIG. 2 is a schematic block diagram depicting the construction of a RD. Referring to FIG. 2, a reminder device (reminding device) capable of executing reminding functionality contains a central processing unit (CPU) 23 to execute various application programs. The CPU 23 preferably includes one or more processors/micro-processors and/or one or more digital signal processors. Said CPU 23 can execute communication protocols, accept the transmitted information from the scheduler device, receive/transmit downloadable data and execute or initiate execution of routines/functions like display, remind, manage, and process. A transmit/receive antenna 28 connected to transceiver 25 through transmit/receive port 27 for transmitting and receiving FSMP, and signals such as selective call signals, command data signals and information data signals. Transceiver may be of any conventional design such as those utilized in two-way pagers, mobile radios or portable cellular telephones and similar devices or products. One or more input/output ports 29 like RS232, USB, SPI, I2C etc is connected to CPU for download/upload of data from/to other devices like RD, printer etc. This interface contained in the RD is also used to communicate information between itself and scheduler device or any secondary device. The user interface connected to CPU 23 contains appropriate input and output devices including, for example, a keyboard 22, a voice input/output device 26 or an alert transducer. The reminder device typically includes a display 21 like LED display or LCD display or LCD with touch screen or CRT display. The user interface may include a keyboard 22 along with necessary switches or other types of input/output devices like voice input/output device 26 or scanner or touch sensor or the like and may be of any sort, which allows the user to communicate with the CPU 23.

A memory means 24 is coupled with the CPU for storing the received FSMP or any other data required for reminding function. Memory means may be static RAM, volatile/non-volatile RAM, Dynamic RAM, Flash, EEPROM or any type of memory suitable for the data to be stored and addressed in a manner that allows them to be accessed, written and managed. A Real Time Clock (RTC) supplies time data to be used to control the reminding operation. Alternatively, the processor/controller may also have an on-chip RTC or a programmable real time clock or a real time source or a timer for counting time and may contain software driven routine for comparing the real time with the scheduled prescription time data. The CPU 23, memory means 24, and RTC are suitably connected to each other. A keyboard or any other pointer device is used to input various instructions to the CPU. A display screen 21 displays various types of information in the form of a text and/or an image/symbol. Alarm means intended for reminding each dose of each prescribed medication is included in RD for urging or reminding a patient for taking each medication at proper time. As a matter of fact, most of the hand held devices like cellular phones or personal digital assistants, wherein the reminding function could be integrated, inherently consist of a single or plurality of intrinsic alarm means. An integrated reminding device, for example, could be a cellular phone, which generally includes a CPU, ROM, RAM, and interfaces. It includes a display driver for driving the display unit, a touch-sensitive panel, a light source driver, and an image data generator, which are connected to the CPU and controlled thereby. The image data generator delivers image data to the display. It also includes a real time clock or a real time source. A transmit/receive antenna/port is connected to transceiver for transmitting and receiving signals such as selective call signals, command data signals and information data signals. Software driven routine could be added for comparing the real time with the reminding schedule, and for implementing reminding alarm function at each timed occurrence of each scheduled drug utilizing time, and simultaneously for displaying the pertinent textual and/or symbolic data of relevant prescribed medication/s.

A CPU of the reminder device may accept FSMPs from different scheduler devices. The FSMP may be received by means of transmit/receive unit through transmit/receive port via a wireless or wire-line link or wired network or wireless network or cell network or other network connection. Said communicated input may be a text file, a data feed, an image, or the like, or instructions for a display of text and/or image, or instructions for alarm for reminding, or the like. The received communication may include the FSMP with embedded/attached application software or may contain only the FSMP file, wherein the application software is present or preloaded in the communicated reminder device, which is intelligent enough to operate upon. The received FSMP, received by the receiving reminder device, is passed to the computing element via the data communication interface. The computing element processes the data and parses metadata from it, that is, parses information related to the data such as an intended recipient or group of recipients or priority of the data etc. The processor may also format the received data, which preferably has a format that can be compressed and stored. A reminding device having intrinsic software for performing the reminding function can audio-visually remind a user with received FSMP, which includes only ‘scheduled prescription data’. Or in the absence of such intrinsic software, such software could be attached/embedded with the SMP while formatting. After downloading of FSMP, such software is detached and is stored in the memory as application program. Said attached/embedded software instructions include instructions for setting each time of day of each dose of each medication in the programmable clock of the reminder device for actuating the alarm means and to display related text/symbol data. Or said FSMP may be attached/embedded with instructions compliant with said reminder device for the CPU of the RD for keeping track of current standard time, regularly comparing said current standard-time with medication time specified by said scheduled prescription time data, and upon the timed occurrence of each administration time, to generate an alarm signal and to display related text/symbol data for every dose of medication to be administered at that time instant. Said application software generally refers to files that contain instructions or codes to be executed, typically called as program files or the executable files, which define the operation or structure of an application or system. The CPU, coupled with said memory means and RTC/on-chip-RTC/timer, executes operations comprising of storing said executable file in the memory means and running the executable file for a plurality of times for automatically generating periodic alerts and simultaneously displaying related pertinent text and/or graphics and/or symbols.

One skilled in the art would appreciate a method of implementing the reminding functionality that is not dependent on the operating system platform like Windows, PalmOS, Linux etc of the reminding device or intrinsic software or the file format of reminding software like .exe etc. To have such a ‘platform-independent mechanism’ of reminding function, the scheduler file while formatting can be embedded with instructions to perform reminding function. Such instructions embedded in the SMP are compatible with target hardware and perform programming/monitoring of timer to generate alarms and perform the reminding actions. The instruction execution of embedded instructions in the FSMP just have to be triggered/activated. This process is similar to the way a virus is triggered by host system. Said triggering/activation can either be done by inputting a suitable command or can occur by default upon mere downloading of FSMP file in a reminder device. The FSMP, upon triggering, uses the time and medication information contained in itself to perform the reminding actions. To exemplify, the timer is programmed using assembly language instructions specific to the timer. Said programming comprises of loading the timer buffer with the absolute time at which alarm is to be generated or the time with reference to current time, after which alarm is to be generated. The timer generates an alarm when said programmed time occurs. The alarm interrupts the CPU, which thereupon performs the reminding actions.

Intrinsic or received application software programs the programmable real time clock for setting and sounding alarms consistent with the received formatted scheduled prescription data. Alarm settings in RTC include alarm time in hours, minutes with/without AM/PM, or alarm time and date in hours, minutes, year, month, date with/without AM/PM and/or day-of-month specified for each dose of each medication. Such clock timing circuitry for setting and sounding alarms is a very well known art and is used in a number of consumer items. Or the reminding at each specified drug administration time could also be achieved by comparing ‘alarm time’ or ‘alarm time and alarm date’ with current time in RTC. Typically, the CPU, under its intrinsic or received application software programs, performs software driven routine of comparing the real time with the scheduled prescription time data stored in data storage to execute the reminder function at the occurrence of each prescribed administration time. Thus, the CPU continuously keeps track of the standard time in RTC and continuously compares stored drug administration times. The CPU is programmed to generate a dosage alarm signal upon the timed occurrence of a drug administration time specified in the programmed dosage schedule. In response to dosage alarm signal, the driver circuitry generates a reminding/acoustical alarm signal to generate vibrations and/or to generate a buzzer/signal/beeper and/or to broadcast an audio message and/or to generate an illumination/blinking and simultaneously displays a related concise and customized form of alphanumeric and/or graphical and/or symbolic display.

An alarm such as a buzzer or a speech synthesizer may operably be coupled to the CPU, which includes means for generating a verbal sound signal. Such generation of signal is based upon a programmed instruction, which corresponds to the scheduled prescription time data. An amplifier may be coupled to the speech synthesizer for providing an audio signal to a loudspeaker. A single or plurality of conventional alarm means could be included in the reminding device. Such alarm means may include: a buzzer/speaker for emitting an audio signal, or a light source on the housing for illumination/blinking, or a tactile stimulation means such as vibrating the housing, or a transmitter adapted to transmit through a transmit/receive port via any media like free space or wire, or a voice signaling achieved through a recording or digital generation, or a wireless output as a transducing element to activate a triggering of secondary devices (e.g., alarms, patient assistance equipment, etc.), or an audio signals to output recorded signaling, or a wireless output transmitting alarming information to other intelligent secondary devices. Upon generation of the dosage alarm signal, the CPU (computing means) accesses the related scheduled prescription display data stored in data storage unit. The accessed data is then provided to display interface circuitry. The display interface circuitry generates signals, which are provided to display device so as to graphically display the related textual/symbolic scheduled prescription display data in accordance with the programmed dosage schedule. Upon hearing the alarm signal, the patient is reminded to comply with the prescribed dosage schedule frame being visually displayed on the display surface of the display screen. Or, a user-initiated action may be required to initiate the display of either visual or recorded identification and instructional information. The reminding device may first emit an audio, visual or tactile stimulus, and then an action by the user will cause the device to display the appropriate audio and/or visual information. Display of such audio or visual information may be accomplished in a manner so as to preserve the privacy of the user in hearing or viewing such information.

RD provides means for the user to acknowledge the reminding and indicate that he/she has taken the prescribed medication. Such compliance (acknowledgement) could typically be done by pressing a key/touch-screen or a combination of keys or by shaking the device (motion/vibration) or voice input or closing the flap of a mobile phone etc. Each compliance could be recorded. Or the reminder device could be interfaced with other existing signaling or acknowledging devices, which notify that patient has followed the reminded schedule. The compliance can be complete or partial wherein, complete compliance is done when all the instructions and/or medication at that time instance are followed; and partial compliance is done to convey that medication cannot be followed completely because of some reasons like unavailability of medicine etc. The said partial compliance is done by selective input. The application software of the reminding device would keep track of the compliance, would store the same in the memory means and would format it to make it transmittable. This compliance status may be sent to any intelligent device or it may be transferred to a similar intelligent device upon visiting the doctor.

FIG. 9 depicts a flow diagram illustrating one version of process-flow to implement the reminding functionality for the received FSMP in a reminding device. The operation starts at step 161. Once a communication is received (at step 162), the CPU proceeds if the authentication is acceptable (step 163). If the authentication is valid, then at step 164, the received FSMP is stored and the reminding process is activated. Here, the entire programmed dosage schedule (scheduled prescription time and display data), and if included, an application program applicable in the reminder device is stored in the memory means of the reminder device. At step 165, the computation means, continuously keeping track of the real time in the RTC under its control program, checks the scheduled prescription time data for the occurrence of a scheduled medication administration time. The decision diamond 166 checks whether the current time is one of the scheduled medication times. If ‘no’, the process goes to step 165. If ‘yes’, then at step 167, the stored programmed dosage schedule display data consisting of text and/or symbols and/or icons etc pertaining to those medications to be utilized at that moment are retrieved. Promptly, at step 168, reminding alarm signal is generated at that occurrence of scheduled medication time to generate vibrations and/or to generate a buzzer/signal/beeper and/or to broadcast an audio message and/or to generate an illumination/blinking etc. Likewise, scheduled prescription display related text and/or symbols and/or images pertaining to those medications to be utilized at that instant are displayed. At decision diamond 169, the CPU checks whether the patient has complied or has implemented a function like snooze. If snooze is performed, then the process proceeds to step 171, wherein the system waits for the defined snooze time, and then the process goes to step 168. If complied, then the decision diamond 170 checks whether the entire duration of prescribed medication is over. If ‘no’, then the process goes to step 165. If ‘yes’, then the process ends at step 172.

The present invention may include a system, which has recognition means for recognizing a user. This means that a user is recognized by the system, when he/she starts to work with the scheduler/reminder device to input/manipulate at the operator interface. Recognition can take place, for example, by means of a password. Recognition can however also take place by means of biometric data, for example, the recording or reading of a fingerprint, or voice input via the input means or biometric data like iris scanning or other methods for pattern recognition to recognize a user. Another embodiment of the present invention comprises of a single device consisting of both the scheduler as well as the reminder function. In yet another embodiment, said program/software could reside as well as run on the same computing system or it may reside in one and run on another computing system or it may reside and run in the same computing means but used from another. The hereinabove mentioned method of usage from remote computing means may be realised by means like internet, intranet or any other interconnection systems. The usage may be accomplished with the aid of scripts or servers.

As will be appreciated by one of skill in the art, the scheduling and/or reminding aspects of the present invention may be embodied as a method, or a dedicated device, or integrated device, or data processing system, or computer program product. Accordingly, the present invention may take the form of an entirely hardware embodiment, an entirely software embodiment or an embodiment combining software and hardware aspects. The present invention may take the form of a computer program product on a computer-usable storage medium having computer-usable program code means embodied in the medium. Any suitable computer readable medium may be utilized including hard disks, CD-ROMs, optical storage devices, magnetic storage devices, or computer memory.

The above description thus indicates certain embodiments of the present invention, and it is apparent to those expert and skilled in the art that numerous versions and modifications and variations may be made without departing from the scope of the present invention. The present invention may, of course, be carried out in other specific ways than those herein set forth without departing from the spirit and essential characteristics of the invention. The detailed description of the invention with reference to drawings should therefore be considered in all respects as illustrative and not restrictive, and all changes coming within the meaning and equivalency range of the detailed description are intended to be embraced therein.

We claim:

1. A medical prescription scheduler for reminding and compliance,
wherein scheduling means are provided for facilitating a quick scheduling of a medical prescription and for formatting and transmitting said prescription to a reminder device;
and wherein when unpacked in the reminder device, the formatted scheduled medical prescription realizes programming of the reminder device;
and wherein the programmed reminder device is capable of reminding each dose of each medication of said prescription till compliance.

2. A medical prescription scheduler for reminding and compliance as claimed in claim 1, wherein said scheduling means provides facilitated scheduling of a medical prescription, and carries out formatting and transmission of said prescription, wherein said scheduling means includes a computing system and a method for facilitated scheduling of a medical prescription, said computing system comprising:
a central processing unit (CPU) to execute application programs;
a memory means for storage;
a display means for display;
said CPU interfaced to said display means and capable of displaying plurality of graphical user interfaces;
an input means for entering or accessing or searching or selecting;
input/output interface means capable of interfacing with said CPU and to an external electronic device to exchange data therewith;
transmission module comprising transceiver and transmit/receive antenna for transmitting and receiving;
said transmission module, said CPU and logic-based program including CPU-executable code loaded in said memory for formatting and transmitting said prescription to desired elements like reminder devices or data storage or pharmacy or printing means or any other computing device;
and wherein said method for facilitated scheduling of a medical prescription drives said computing system or functions on said computing system, said method comprising:
a plurality of distinct graphical user interfaces capable of operating on a computing platform configured to select and to enter mainly patient/drug related data, wherein target locales receive inputs or are meant for navigation or display or search or facilitate operations;
logic-based application program including CPU-executable code for facilitated selection and input of a drug name and drug form, and for automatically computing and inputting in terms of quantity and strength of each drug dose and/or technique of drug dose administration and/or frequency of drug doses per day and/or duration of drug administration for a selected drug, wherein recommended indication-wise and form-wise daily dosage range, recommended range of divided dosages per day,
recommended range of maintenance dosage, recommended range of duration of drug administration, drug interactions and drug safety alerts related to said selected drug are correlated, analyzed and judged with respect to inputted drug form of said selected drug and patient-specific information like age, gender, weight, clinical conditions, severity of ailment, allergy and physical status of the patient;
logic-based application program including CPU-executable code for automatically computing and inputting in terms of time of day data of each drug dose utilization time in hours and minutes, or hours, minutes, year, month, date with/without AM/PM and/or day, and/or associated food relation for a selected drug, wherein duration of absorption and systemic bioavailability of said selected drug, interactions with food pertaining to absorption and bioavailability of said selected drug, region-wise or user defined pre-programmed food intake times, and region-wise or user defined pre-programmed time relation regarding before/with/after food intake are correlated, analyzed and judged with respect to computed said quantity and strength of each drug dose and/or said technique of drug dose administration and/or said frequency of drug doses per day of said selected drug;
a program for identifying precautionary instructions related to said selected drug for inputting and for display.

3. A medical prescription scheduler for reminding and compliance as claimed in claim 1, wherein said memory means (memory) may be read-only memory (ROM) and/or random access memory (RAM) and/or erasable programmable read only memory (EPROM) and/or electrically erasable programmable read only memory (EEPROM) and/or magnetic/optical cards and/or any type of media suitable for storing electronic data and/or a combination of known FLASH, RAM, NV-RAM, ROM, EEPROM and/or magnetic/optical memory and/or any type of disk including hard disc, floppy disk, optical disk, CD-ROM, DVD, magnetic-optical disks, and/or may be stored in any other external storage media that could be accessed by the computing means;
and wherein said memory means is designed for storing information related to plurality of prescription drugs, wherein said plurality of prescription drugs are stored preferably in an alphanumerical or alphabetical indexed order,
wherein information related to each of said plurality of prescription drugs contains ingredient/ingredients of therapeutic agent/agents, and wherein for each therapeutic agent (generic name) information is stored regarding highlights of therapeutic actions, indications, recommended range of indication-wise and form-wise dosage, recommended range of maintenance dosage, recommended range of divided dosages, recommended range of duration of drug administration, safety alerts, contraindications, precautions, drug interactions, potential hazards, adverse effects, lab interference, and pharmacokinetics comprising duration of absorption, systemic bioavailability, activity, metabolism and elimination, interactions with food pertaining to absorption and bioavailability, region-wise or user defined food intake times, region-wise or user defined time relation regarding before/with/after food intake, and for storing patient related information, and for storing prescription data, and for storing application software including CPU-executable code and assorted operating variables and parameters for the processor, and for storing advertisements, and for storing relational datasets/databases comprising relational information related to constraints with respect to age, gender, weight, clinical conditions, allergy and physical status of a patient, drug association and drug intake versus each of the therapeutic agent.

4. A medical prescription scheduler for reminding and compliance as claimed in claim 1, wherein selection of a suitable GUI screen having distinctive input regions is on the basis of manner in vogue that exists in writing a medical prescription, or on the basis of user selection, or said selection of a suitable GUI screen having distinctive input regions suitable for a selected drug form for displaying and entering related computed outputs is on the basis of selection of a drug name and/or its drug form;
wherein graphical user interfaces include insightfully designed GUI screens,
wherein each individual GUI screen has distinctive input regions suitable to display and enter relevant computed outputs of related drug form;
wherein a selected drug form may be a drug form of a tablet or a capsule or an elixirs or a liquid oral or eye/ear/nasal drops or a nasal spray or an oral spray or an oral rinse or a mouth wash or a powder or a sublingual tablet or a suppository or a gel or a pessary or a topical steroidal/non-steroidal anti-inflammatory drug/drugs or an antiseptic solution or a lotion or a cream or a balms or an ointment or a subcutaneous injection or an intramuscular injection or an intravenous injection or an infusion fluid or a contrast media or a dressing appliance etc;
and wherein said outputs may be a drug form and/or quantity and strength of each drug dose and/or frequency of drug doses per day and/or time of each dose administration and/or technique of drug administration and/or food relation and/or precautionary instructions and/or duration of administration of a selected drug and/or relational analysis;
and wherein for each said drug form, a related subset of said outputs or entire set of said outputs is required to be computed.

5. A medical prescription scheduler for reminding and compliance as claimed in claim 1, wherein said CPU, said memory, and application software including CPU-executable code loaded in said memory for facilitated selection and input of a drug name and/or drug form, and for automatic computing the entire set or a related subset of said outputs on the basis of selection of a drug name and/or its drug form for displaying and entering in relevant selectable input boxes of a suitable GUI screen, said facilitated selection and said automatic computing comprising:
a selectable input box for a drug name input, actuated by sequential input of initial letters of intended drug name, wherein, a drop down list of plurality of completion candidates associated with inputted letter/letters is displayed,
wherein said completion candidates are displayed in an alphabetically or alphanumerically ordered listing, and wherein narrowing criteria are associated with each successive sequential input or by actuating scrolling means enabling a user to identify, select and input the intended drug name;
a selectable input box for drug form input, actuated by selection of the drug name, wherein, a drug form is automatically selected if a single drug form exists, or a drop down list of plurality of members of drug forms related with the inputted drug name is displayed for manual selection and inputting;
and wherein a total daily drug dose is automatically computed by correlating, analyzing and judging the age, gender, weight, clinical conditions, and severity of ailment of the patient with respect to recommended indication-wise and form-wise daily dosage range and maintenance dosage range of the selected drug;
selectable input boxes for inputting the quantity and strength of each drug dose and frequency of drug doses per day, wherein said quantity and strength of each drug dose and frequency of drug doses per day is automatically determined and inputted by correlating, analyzing and judging duration of absorption, systemic bioavailability, activity, metabolism and elimination of the selected drug, recommended range of indication-wise and form-wise dosage and divided dosages per day and maintenance dosage range of the selected drug with respect to the selected drug name, drug form and said total calculated daily dose of the selected drug;
selectable input boxes for inputting the time of day data of each drug utilization time and its food relation, wherein said time of day data of each drug utilization time and its food relation is automatically determined and inputted by correlating, analyzing and judging time of day data of region-wise or user defined food intake times, region-wise or user defined time relation regarding instruction of with or before or after food intake, and interactions with food pertaining to absorption and/or bioavailability of the selected drug and its drug form with respect to said frequency of drug doses per day;
a selectable input box for automatically determining and inputting the duration of drug administration, wherein said duration is automatically determined by correlating, analyzing and judging the age, weight, clinical conditions, and severity of ailment of the patient with respect to recommended range of the duration of administration of the selected drug and its drug form;
and wherein the technique of drug dose administration is automatically determined by correlating the selected drug name and/or its drug form;
and wherein the automatically determined and inputted said quantity and strength of each drug dose and/or said technique of drug dose administration and/or said drug utilization time and its food relation and/or said frequency of drug doses per day and/or said duration of drug administration of the selected drug is alterable by manual modification;
judging and appending a precautionary instruction for the selected drug,
wherein programmed memory has pre-programmed drug safety alerts for each drug and concurrent administration of drugs;
or wherein said CPU, said memory, and application software including CPU-executable code loaded in said memory facilitating for manual input,
wherein quantity and strength of each drug dose and/or frequency of drug doses per day and/or time of each dose administration and/or technique of drug administration and/or food relation and/or precautionary instructions and/or duration of administration are manually inputted in selectable input boxes provided by said suitable GUI screen, wherein said suitable GUI screen is selected on the basis of selection of the drug name and its drug form.

6. A medical prescription scheduler for reminding and compliance as claimed in claim 1, wherein said CPU, said memory, and application software including CPU-executable code loaded in said memory, assists a prescriber by performing a process of relational analysis while scheduling of a medical prescription, said process of relational analysis comprises:
said memory means for storing inputted patient related information like age, sex, weight, allergy, clinical conditions, severity of ailment, and for storing drug related information like generic name/names of currently inputted drug name, and generic name/names of previously inputted drug name/names and generic name/names of currently administered drug name/names of medication, and information pertaining to each brand name for its ingredient generic name/names of drug/drugs, and for storing relational information pertaining to incompatibility or cautionary or advisory information relating to each generic name of drug with respect to food intake, and with respect to concomitant administration of medicaments, and with respect to patient related information like age, sex, weight, allergy, physical status, clinical conditions, severity of ailment;
computing means for retrieving said drug related information and said inputted patient related information, and for performing relational analysis of retrieved drug related information with respect to retrieved inputted patient related information for identifying and displaying incompatibility and/or cautionary/advisory information comprising drug interactions, safety alerts, contraindications, precautions, potential hazards, adverse effects, food interactions and lab interference;
display means for displaying said incompatibility and/or said cautionary and/or said advisory information if any.

7. A medical prescription scheduler for reminding and compliance as claimed in claim 1, wherein said CPU, said memory, and application software including CPU-executable code loaded in said memory for facilitated selection and input of pathology test/tests or radiological or physiotherapy procedure/procedures, wherein selection of the suitable request GUI screen for said facilitated selection and input is on the basis of clicking/selecting REQUEST button, said facilitated selection and input comprising:
a selectable input box for inputting a member classified under criteria, actuated by selecting the term criteria, wherein, a drop down list of members classified under said criteria like pathology, radiology, radiodiagnosis, physiotherapy are displayed enabling a user to identify, select and input the required member;
a selectable input box for selecting and inputting a name of system-wise caption classified under the inputted member of said criteria, actuated by selecting said inputted member, wherein a drop down list of system-wise captions classified under said inputted member are displayed enabling a user to identify, select and input the required name of said system-wise caption;
a selectable input box for selecting and inputting a member classified under the selected name of system-wise caption, actuated by selecting the inputted name of system-wise caption, wherein a drop down list of members classified under said inputted name are displayed enabling a user to identify, select and input the required member or members of said name of system-wise caption;
or wherein said selected request GUI screen offers a selectable input box for inputting a name of test/tests of pathology or procedure/procedures of radiology or radiodiagnosis or physiotherapy, actuated by sequential input of initial letters of intended test or procedure, wherein, a drop down list of plurality of completion candidates associated with inputted letter/letters is displayed, wherein said completion candidates are displayed in an alphabetically or alphanumerically ordered listing, and wherein narrowing criteria are associated with each successive sequential input or by actuating scrolling means enabling a user to identify, select and input the intended name of a test or a procedure;
or wherein said selected request GUI screen offers a list of available tests in pathology, procedures in radiology and radiodianosis and physiotherapy,
wherein a user can select and input the intended name/names of the required pathology test/tests or radiological/radiodiagnostic/physiotherapy procedure/procedures from the provided list.

8. A medical prescription scheduler for reminding and compliance as claimed in claim 1, wherein each said GUI screen having distinctive input regions includes a first field of a principal zone signifying the prescription-scheduling/data-entry template and a second field of a smaller zone of one or more floating/pop-up windows for displaying an advertisement (ad) or ads,
wherein the ad/ads function like a virtual medical representative,
wherein each stored ad is preferably either linked to a generic/brand name of a drug or linked to a clinical condition or related to a sponsor company specific medicinal or surgical or diagnostic product or symbol or logo;
and wherein the stored advertisements for display comprise sponsor related messages and/or audiovisual ads and/or visual ads and/or ads containing textual and graphical material and/or images and/or URL addresses of the sponsor;
wherein any of the drug-name/clinical-condition related ad or any of the ad field may have a single or multiple sponsors permanently or temporarily associated with it;
and wherein a linked ad is displayed as soon as a related drug name or a related clinical condition is selected/inputted;
and wherein the instant a subsequent clinical condition or a subsequent drug name is selected/entered, an ad/ads linked to that entered clinical condition or drug name respectively are displayed;
and wherein displaying of ad/ads preferably continue till the entire prescription is scheduled or till the scheduling software is active/functioning.

9. A medical prescription scheduler for reminding and compliance as claimed in claim 1, wherein while scheduling of a prescription, for each inputted/deleted entry related to each medication like name, form, dosage, technique of drug administration, time of medication, frequency, food relation, precautionary instructions, and duration of administration, a text and symbol section (TSS) is updated simultaneously by inserting/removing respectively a corresponding text and/or symbol data and/or time of day data associated with each dose of each medication along with data related to duration of administration;
wherein said TSS comprises scheduled prescription display data, which includes textual data of name of drug, textual and/or symbolic data for drug form like tablet or capsule, textual and/or symbolic data for dosage strength, textual and/or symbolic data for technique of drug administration like oral or injectable or intravaginal or sublingual etc and/or textual/symbolic data for precautionary instruction for each dose of each medication;
and wherein said TSS comprises scheduled prescription time data, which includes time of day data that identifies each drug dose utilization time preferably in hours, minutes, with year, month, date, with/without AM/PM and/or day, or hours, minutes and AM/PM for each dose of each drug, and time data that identifies the duration of administration of each drug.

10. A medical prescription scheduler for reminding and compliance as claimed in claim 1, wherein formatting of a scheduled medical prescription in a transmittable format for transmission comprising:
CPU, coupled with programmed memory preprogrammed therein with logic-based program including CPU-executable code, for formatting a scheduled medical prescription so as to realize said programming of a receiving reminding device;
wherein a programmed dosage schedule file is generated comprising said scheduled prescription display data and said scheduled prescription time data;
wherein application programs compliant with said reminder device are generated for attachment to said programmed dosage schedule file for concomitant reminding by means of alarm and display for each dose of each medication at timed occurrence of each drug utilizing time, wherein instructions are included for programming the programmable clock of the reminder device for each time of day of each dose of each medication for actuating the alarm means and for displaying related text and/or symbol data, or wherein instructions are included for central processing unit of the reminder device for keeping track of current standard-time, regularly comparing said current standard-time with drug utilization time for each dose of each medication (dosage schedule data), and upon the timed occurrence of an administration time specified in the dosage schedule data, to generate an alarm signal and to display related text and/or symbol data;
wherein said programmed dosage schedule file with/without attachment of said application programs forming content data and combining said content data with related metadata containing information and/or instructions regarding said content data to form an input scheduler file;
wherein formatting said input scheduler file based on format instructions and based on format specifications compliant with the recipient reminder device and/or its scheduled medical prescription reminder application program to form formatted scheduled medical prescription (FSMP);
and formatting said formatted scheduled medical prescription in a transmittable format for transmission in a reminder device or for downloading in a reminder device or on a storage medium like flash card or SIM card to be used by a reminder device;
or wherein CPU, coupled with programmed memory preprogrammed therein with logic-based program including CPU-executable code, for formatting a scheduled medical prescription in a transmittable format for transmission to a printer or a database or a computing device or a pharmacy.

11. A medical prescription scheduler for reminding and compliance as claimed in claim 1, wherein said scheduling means is a modified computing device, wherein either the existing hardware/software is suitably adapted or the requisite hardware/software is incorporated so as to accomplish the scheduler function, and wherein said modified computing device is modification of a personal computer or a desktop computer or a laptop computer or a handheld computer or a pocket personal computer or a terminal or other computers or hand-held devices such as personal digital assistants or palmtop computers or digital diaries and the like, or a dedicated scheduler device, or a cellular/mobile phone or a smart phone or a personal handy phone or a telephone, or other devices or computing devices capable of providing an input signal to the command processor, or a computing device which can utilize any appropriate computer readable medium having computer-executable instructions/code like hard disks or CD-ROMs or magnetic/optical storage devices etc to execute the scheduler function;
or wherein a dedicated scheduler device includes said scheduling means;
or wherein a dedicated/modified device includes said scheduling means along with reminding means providing reminding function for reminding a patient to take each dose of each medication of said prescription.

12. A medical prescription scheduler for reminding and compliance as claimed in claim 1, wherein said reminder device provides receiving means for receiving said formatted scheduled medical prescription and reminding means for providing reminding function for reminding a patient to take each dose of each medication of said prescription, wherein reminding alerts being timed to coincide with scheduled prescription time data to alert the patient for required dosage compliance, said reminder device comprising:
a central processing unit (CPU) to execute various application programs;
a transmit/receive antenna connected to transceiver for transmitting and receiving signals;
transceiving means for transmission and for receiving said formatted scheduled medical prescription via wireless or wired communication;
means for verifying sender verification of received said formatted scheduled medical prescription;
an input/output means for user interaction;
a programmable real time clock (RTC) means or an on-chip RTC or a timer for counting time;
a memory means for storage;
reminding means comprising said CPU coupled with said RTC or said timer and said memory preprogrammed therein with an intrinsic/received CPU-executable application software for carrying out the reminding function at timed occurrence of each prescribed administration time till compliance;
acknowledgment means, interfaced to said CPU, for generating an acknowledgment signal;
a switch for terminating/snoozing a generated alarm signal.

13. A medical prescription scheduler for reminding and compliance as claimed in claim 1, wherein execution of said reminding function comprising:
said reminding means for regularly tracking the current time and scheduled prescription time data of received said formatted scheduled medical prescription and for regularly comparing current time with each prescribed administration time specified in said scheduled prescription time data for employing reminding function at timed occurrence of each prescribed administration time;
or alternatively, said reminding means for programming programmable real time clock means for setting and sounding alarms consistent with the received formatted scheduled medical prescription, wherein alarm settings in the real time clock device include alarm time in hours, minutes and AM/PM, or hours, minutes, year, month, date with/without AM/PM and/or day specified for each dose of each medication for employing reminding function till compliance;
alarm signal generating means for generating a dosage alarm signal at timed occurrence of each prescribed administration time as specified in said scheduled prescription time data for alerting a user;
wherein said alarm signal actuating audio alarm means for audio signal emission like beep/buzzer/ring upon the actuation thereof and/or light means for illuminating/blinking upon the actuation thereof and/or vibrator means for vibrating the housing upon the actuation thereof;
and wherein said alarm signal actuating display means for visually displaying dose/doses of medication to be administered at that time instant,
wherein pertinent data related to said dose/doses as specified in said scheduled prescription display data is displayed in graphical and/or symbolic and/or alphanumeric textual representation, which includes textual data of name of drug and/or textual or symbolic data for drug form like tablet or capsule and/or textual or symbolic data for dosage strength and/or textual data of precautionary instruction/instructions and/or textual or symbolic data for technique of administration like oral or injectable.

14. A medical prescription scheduler for reminding and compliance as claimed in claim 1, wherein in the absence of said intrinsic application software in said reminder device, realization of said reminding function comprising:
said receiving means of said reminder device receiving a formatted scheduled medical prescription, wherein instructions to perform reminding function are embedded, which are compatible with hardware of said reminder device, and wherein similar to the way a virus is triggered by a host system, the embedded instructions have to be activated/triggered for their execution, and wherein the triggering/activation and execution of said embedded instructions could either be done by inputting a suitable command or by default upon mere downloading said prescription, and wherein upon triggering/activation, said instructions utilize said scheduled prescription time data and said scheduled prescription display data contained in received said prescription to perform the reminding function, wherein the performance of said function is independent of said intrinsic application software or independent of operating system platform of said reminding device;
or the received formatted scheduled medical prescription encloses an attached application software for reminding function, which is detached in said reminding device after downloading of said prescription and is stored in the memory as an application program, and wherein said software reads said scheduled prescription time data and said scheduled prescription display data from received said prescription and utilizes it to perform reminding function.

15. A medical prescription scheduler for reminding and compliance as claimed in claim 1, wherein said reminding device is a modified electronic device, wherein; either the existing hardware and/or software is suitably adapted or the requisite hardware and/or software is incorporated so as to accomplish the receiving and reminding function, and
wherein said modified electronic device is a portable telephone like a cellular/mobile phone or a smart phone or a personal handy phone or a car telephone or a telephone or a maritime mobile radiotelephone or a pager or the likes, or wrist-worn devices, or a timepiece or a wristwatch, or hand-held device such as personal digital assistant or palmtop computer or digital diary or personal/laptop computer or interactive phone devices or household appliances or a television or a television set top box or handheld computers or other computers and the like or other devices capable of bearing and implementing the reminding application;
or wherein said reminding device is a dedicated reminding device including said receiving function and said reminding function.

16. A medical prescription scheduler for reminding and compliance as claimed in claim 1, wherein for effective reminding, said CPU coupled with said memory in said scheduler means or said reminder device for switching the text element/elements of said scheduled prescription display data from prescriber's language (first language) to a patient's language (second language), said switching comprising:
said text element/elements of said scheduled prescription display data are words/numbers like tablet, capsule, brand/generic drug name, ‘2’, ‘500 mg’, precautionary instruction like ‘do not drive’ etc to be displayed in said reminder device;
relational memory means for storing relational data of electronically stored translations for realizing the switching between several languages;
inputs means for specifying said second language and commanding the switching of said element/elements in said first language to said second language;
access means for addressing said memory means for identifying each said text element/elements representing a first language and retrieving related text element/elements representing a second language equivalent in meaning to said text element/elements of first language;
said CPU replacing said text element/elements representing said first language by retrieved related text element/elements representing a second language and thus switching entire text element/elements of said scheduled prescription display data from said first language to said second language;
or wherein a translation software is embedded in said FSMP to facilitate translation operation from first language to second language as per the language settings of the reminding device.

17. A programmed computer product, wherein computer usable program code means to carry out scheduler function are embodied in computer usable storage medium, said programmed computer product comprising:
a recording medium;
means, recorded on recording medium, for storing information related to plurality of prescription drugs and pharmacological information related to constraints regarding each generic name of drug with respect to patient related information like age, gender, weight, clinical conditions, allergy, physical status, and for storing relational information related to drug intake and drug association, and for storing advertisements related to generic/brand name of drugs or clinical conditions;
means, recorded on recording medium, for storing logic-based processor-readable application programs including CPU-executable code/instructions compliant with the processing system of a host;
means, recorded on recording medium, for directing the processing system to install graphical user interfaces operable on a computing platform and configured to select and enter mainly patient/drug related data, wherein target locales receive inputs or are meant for navigation or for search or for facilitate operations, wherein each GUI screen of said graphical user interfaces is an insightfully designed GUI screen having distinctive input regions, and wherein selection of a suitable GUI screen from said graphical user interfaces is on the basis of a preferred sequence or on the basis of selected drug and/or its drug form or on the basis of user inputs;
means, recorded on recording medium, for directing the processing system to identify inputted patient-specific information like age, gender, weight, clinical conditions, severity of ailment, allergy and physical status of the patient, and to identify inputted drug specific information like currently administered drug/drugs including currently inputted (prescribed) drug/drugs;
means, recorded on recording medium, for directing the processing system to utilize said recorded logic-based application program including CPU-executable code and said information related to prescription drugs and generic name of drugs for facilitated selection and input of a drug name and its drug form and for automatically computing and inputting in terms of quantity and strength of each drug dose and/or technique of drug dose administration and/or frequency of drug doses per day and/or duration of drug administration for the selected drug, wherein stored recommended indication-wise and form-wise daily dosage range, recommended range of divided dosages per day, maintenance dosage range, recommended range of duration of drug administration, and drug interactions and drug safety alerts related to said selected drug are correlated, analyzed and judged with respect to identified patient-specific information like age, weight, clinical conditions, severity of ailment, allergy and physical status of the patient;
means, recorded on recording medium, for directing the processing system to utilize said application program and said information related to prescription drugs and generic name of drugs for automatically computing and inputting time of day data of each drug dose utilization time in hours, minutes and AM/PM, or hours, minutes, year, month, date, with/without AM/PM and/or day and/or associated food relation for said selected drug,
wherein duration of absorption, systemic bioavailability of said selected drug, and interactions with food pertaining to absorption and/or bioavailability of said selected drug, region-wise or user defined pre-programmed food intake times, and region-wise or user defined pre-programmed time relation regarding before/with/after food intake are correlated, analyzed and judged with respect to the judged frequency of drug doses per day of said selected drug;
means, recorded on recording medium, for directing the processing system to utilize stored said application program, said relational information and said information related to prescription drugs and generic name of drugs for performing relational analysis of said drug-specific information with respect to said identified patient-specific information for identifying and displaying incompatibility and/or cautionary/advisory relational information comprising drug interactions, safety alerts, contraindications, precautions, potential hazards, adverse effects, food interactions and lab interference, and for judging and appending precautionary instructions for said selected drug and/or concurrent administration of drugs;
means, recorded on recording medium, for directing the processing system to utilize said stored advertisements for display, wherein each advertisement is linked either to a generic/brand name of a drug or to a clinical condition, and wherein a linked advertisement is displayed in an advertisement zone or in one or more floating/pop-up windows once a related drug name or clinical condition is selected/inputted;
means, recorded on recording medium, for directing the processing system to utilize said application program for formatting the scheduled medical prescription based on format specifications compliant with a recipient reminder device or its prescription reminder application program and transmitting the formatted scheduled medical prescription to a reminder device;
means, recorded on recording medium, for directing the processing system to utilize said application program for formatting and transmitting the scheduled medical prescription to desired elements like data storage or pharmacy or printing means or any other computing device;
wherein said recording medium may be a computer readable medium like ROM or RAM or NV-RAM or FLASH or EPROM or EEPROM or magnetic/optical cards or any type of media suitable for storing electronic data or magnetic/optical memory or any type of disk including hard disc, floppy disks, optical disks, CD, DVD, magnetic-optical disks, or any other external storage media that could be accessed by a computing means or other media like writeable compact discs or digital versatile discs;
and wherein said product can be updated or transferred or shared using any suitable recording medium or using any communication link like internet or bluetooth.

18. A programmed computer product as claimed in claim 17,
wherein said selection of a suitable GUI screen having distinctive input regions suitable for a selected drug name and/or its drug form for displaying and entering related computed outputs is on the basis of selection of said drug name and/or its drug form;
wherein said graphical user interfaces include plurality of insightfully designed GUI screens having distinctive input regions suitable to display and enter respective computed outputs of various drug forms;
wherein a drug form may be a drug form of a tablet or a capsule or an elixirs or a liquid oral or eye/ear/nasal drops or a nasal spray or an oral spray or an oral rinse or a mouth wash or a powder or a sublingual tablet or a suppository or a gel or a pessary or a topical steroidal/non-steroidal anti-inflammatory drug/drugs or an antiseptic solution or a lotion or a cream or a balms or an ointment or a subcutaneous injection or an intramuscular injection or an intravenous injection or infusion fluids or a contrast media or dressing appliance etc;
and wherein said outputs may be a drug form and/or quantity and strength of each drug dose and/or frequency of drug doses per day and/or time of each dose administration and/or technique of drug administration and/or food relation and/or precautionary instructions and/or duration of administration of a selected drug and relational analysis pertaining to the selected drug;
and wherein for each inputted drug name and/or its drug form, a related subset of said outputs or entire set of outputs is required to be computed.

19. A programmed computer product as claimed in claim 17,
wherein said facilitated selection and input of a drug name and/or its drug form and said automatically computing and inputting said outputs in relevant selectable input boxes of said suitable GUI screen comprising:
a selectable input box for drug name input, actuated by sequential input of initial letters of intended drug name, wherein, a drop down list of plurality of completion candidates associated with inputted letter/letters is displayed,
wherein said completion candidates are displayed in an alphabetically or alphanumerically ordered listing, and wherein narrowing criteria are associated with each successive sequential input or by actuating scrolling means enabling a user to identify, select and input the intended drug name;
a selectable input box for drug form input, actuated by selection of the drug name, wherein, a drug form is automatically selected if a single drug form exists, or a drop down list of plurality of members of drug forms related with the inputted drug name is displayed for manual selection and inputting;
a total daily drug dose is automatically computed by correlating, analyzing and judging the recommended indication-wise and form-wise daily dosage range and maintenance dosage range of said selected drug with respect to patient related information like age, gender, weight, clinical conditions, and severity of ailment;
selectable input boxes for inputting the quantity and strength of each drug dose and frequency of drug doses per day, wherein said quantity and strength of each drug dose and said frequency of drug doses per day is automatically determined and inputted by correlating, analyzing and judging recommended range of indication-wise and form-wise dosage and divided dosages per day and maintenance dosage range of said selected drug with respect to said selected drug form and said total calculated daily dose;
selectable input boxes for inputting the time of day data of drug utilization time and its food relation, wherein said time of day data of drug utilization time and its food relation is automatically determined and inputted by correlating and analyzing time of day data of region-wise or user defined food intake times, region-wise or user defined time relation regarding instruction of before or with or after food intake, duration of absorption, systemic bioavailability, activity, metabolism and elimination of the selected drug, and interactions with food pertaining to absorption and/or bioavailability of the selected drug with respect to selected said drug name and its drug form, said quantity and strength of each drug dose and said frequency of drug doses per day;
a selectable input box for automatically determining and inputting the duration of drug administration, wherein said duration is automatically determined by correlating, analyzing and judging the age, weight, clinical conditions, and severity of ailment of the patient with respect to selected drug name, drug form, said calculated total daily dose, recommended range of maintenance dosage and recommended range of the duration of administration of the selected drug;
wherein the technique of drug dose administration is automatically determined by correlating the selected drug name and/or drug form;
and wherein the automatically determined and inputted said quantity and strength of each drug dose and/or said technique of drug administration and/or said drug utilization time and/or said food relation and/or said frequency of drug doses per day and/or said duration of drug administration of the selected drug are manually alterable for fine tuning or modification;
if indicated, appending precautionary instructions by correlating, analyzing and judging drug safety alerts for the selected drug and current concurrent administration of drugs with respect to said patient related information.

20. A medical prescription scheduler for reminding and compliance comprising of a complimentary pair of devices, wherein a scheduler device is for simplifying the programming of a reminder device and a reminding device is for reminding each dose of each medication till compliance.
